(19) United States
(12) Patent Application Publication
(10) Pub. No.: US 2025/0235853 A1
(43) Pub. Date: Jul. 24, 2025

(54) CERIUM ZIRCONIUM MIXED OXIDE COMPOSITIONS

(71) Applicant: Neo Chemicals & Oxides, LLC, Greenwood Village, CO (US)

(72) Inventors: Dimitrios PSARAS, Bound Brook, NJ (US); Gary A. GRAMICCIONI, Athens, AL (US); Szu Hwee NG, Singapore (SG); Benedict Hsu You WEI, Singapore (SG)

(73) Assignee: Neo Chemicals & Oxides, LLC, Greenwood Village, CO (US)

(21) Appl. No.: 19/034,325

(22) Filed: Jan. 22, 2025

Related U.S. Application Data
(60) Provisional application No. 63/623,469, filed on Jan. 22, 2024.
(60) Provisional application No. 63/626,197, filed on Jan. 29, 2024.

(51) Int. Cl. B01J 23/83; B01D 53/94; B01J 23/00; B01J 23/89; B01J 35/40; B01J 35/61

(52) U.S. Cl. CPC B01J 23/83; B01D 53/94; B01J 23/002; B01J 23/8946; B01J 35/40; B01J 35/612; B01J 35/613; B01D 2255/1025; B01D 2255/908; B01J 2523/24; B01J 2523/36; B01J 2523/3706; B01J 2523/3712; B01J 2523/48; B01J 2523/842

(57) ABSTRACT

Disclosed herein are mixed oxide compositions containing mixed oxides of cerium, zirconium, and a mixture of iron and strontium. These compositions optionally also may contain additional rare earth dopants. These mixed oxide compositions surprisingly exhibit enhanced low temperature oxygen storage capacity (OSC), even after aging at elevated temperatures. These mixed oxide compositions importantly contain iron and strontium (as oxides) and this mixture of iron and strontium surprisingly provides the mixed oxide composition with improved OSC even after aging at elevated temperatures, in particular improved OSC at lower temperatures. The compositions may be used as catalytic carriers which may be used in gas exhaust purification catalysts.

### RELATED APPLICATIONS

This application claims priority to U.S. Provisional Application No. 63/623,469, filed on 22 Jan. 2024, and U.S. Provisional Application No. 63/626,197, filed on 29 Jan. 2024, the complete disclosures of which are incorporated herein by reference in their entireties.

### FIELD OF THE INVENTION

This disclosure relates to mixed oxide compositions containing oxides of cerium, zirconium, and a mixture of iron and strontium. These compositions optionally also may contain additional rare earth dopants. These mixed oxide compositions surprisingly exhibit enhanced low temperature oxygen storage capacity (OSC), even after aging at elevated temperatures.

### INTRODUCTION

Catalytic materials including ceria zirconia mixed oxides have utility in a number of fields, including abatement of nitrogen oxides, primarily NO and NO₂ (referred to as NOₓ), carbon monoxide (CO), hydrocarbons (HC), such as methane (CH₄) and non-methane hydrocarbons (NMHC), other pollutants from gasoline, compressed natural gas (CNG), and diesel fueled internal combustion engines, such as on-road vehicles, cars, buses and trucks and other off-road gasoline, CNG and diesel engines used in utility vehicles, recreational vehicles and stationary source power generation applications. Emission standards for unburned hydrocarbons, carbon monoxide, and nitrogen oxide contaminants have been set by various worldwide government agencies and must be met or severe penalties will be imposed. To meet such standards, catalytic converters typically are placed in the exhaust gas line of these emission sources. Exhaust gas flows through a catalytic converter and harmful HC and CO are converted into CO₂ and H₂O. NOₓ is preferentially converted into N₂ and O₂ with any unconverted CO, HC, and NOₓ emitted from the exhaust pipe and into the atmosphere as primary pollutants. Catalytic converters contain mixtures of base metal oxides and Platinum Group Metals (PGM).

A three-way conversion (TWC) catalyst includes one or more of these precious metals/platinum group metals (PGM) combined with high surface area base metal oxide/mixed oxide carrier materials. The oxide carrier materials can contain aluminum, titanium, silicon, zirconium, cerium, and mixtures thereof. An oxide carrier material's ability to store and release oxygen helps to regulate catalysis.

There continues to be a need for effective mixed oxide supports for these platinum group metal catalysts to convert emissions more efficiently to less harmful gases. Further, these mixed oxide carrier materials to date primarily have focused on development of materials suitable for catalytic converters operating at high temperatures, which are typical of internal combustion engines. As hybrid internal combustion/electric vehicles become more abundant, it is increasingly important to develop catalytic materials with improved oxygen storage capacity (OSC) characteristics at low temperatures to handle increased on/off cycling and improved conversion of cold start hydrocarbons while maintaining industry standard high temperature stability, performance, and emissions control.

### SUMMARY

Disclosed herein are compositions comprising ceria zirconia with mixed oxides. The compositions may be used as catalytic carriers which may be used in gas exhaust purification catalysts. In particular, the ceria zirconia compositions comprise strontium oxide SrO and iron(III) oxide Fe₂O₃.

Also disclosed herein are washcoat suspension composition for use as a component of a catalytic coating and preparation of these washcoat compositions. The washcoats are applied as a catalyst coating to a substrate. These substrates can be of cordierite, fecralloy metal foil, or foamed ceramic materials.

Disclosed herein is a mixed oxide composition comprising: a) about 1 to about 45 wt. % cerium on an oxide basis; b) about 40 to about 98 wt. % zirconium on an oxide basis; c) about 0.050 wt. % to about 0.50 wt. % iron on an oxide basis; d) about 0.015 wt. % to about 0.20 wt. % strontium on an oxide basis; and e) optionally an additional rare earth dopant selected from the group consisting of lanthanum, neodymium, yttrium, praseodymium, samarium, gadolinium, and mixtures thereof, and wherein when present each optional additional rare earth dopant is present in an amount of about 0.5 to about 15 wt. % on an oxide basis. In certain embodiments, the additional rare earth dopant selected from the group consisting of lanthanum, yttrium, and mixtures thereof present in an amount of about 5 to about 15 wt. % on an oxide basis. In certain embodiments, the amounts of the individual components will vary so that the total amount is about 100% of the mixed oxide composition.

Even though the amounts of iron and strontium are small, these small amounts impart surprisingly improved properties to the disclosed mixed oxide compositions. The mixture of iron and strontium surprisingly provides the mixed oxide composition with improved OSC even after aging at elevated temperatures, and in particular improved OSC at lower temperatures. The mixed oxide composition exhibits no detectable perovskite or pyrochlore phases as determined by XRD even after aging at 1100° C. for 10 hours in air, and the small amounts of iron and strontium can be varied accordingly.

In one embodiment, the mixed oxide composition comprises a) about 30 to about 45 wt. % cerium on an oxide basis; b) about 40 to about 65 wt. % zirconium on an oxide basis; c) about 0.05 wt. % to about 0.50 wt. % iron on an oxide basis; d) about 0.015 wt. % to about 0.20 wt. % strontium on an oxide basis; and e) additional rare earth dopant selected from the group consisting of lanthanum, yttrium, and mixtures thereof present in an amount of about 5 to about 15 wt. % on an oxide basis.

Also disclosed is a catalyst or catalyst composition comprising the mixed oxide composition as an initial feed material.

Further disclosed is a suspension comprising: (i) a Platinum Group Metal (PGM) selected from group consisting of platinum, palladium, rhodium, iridium, osmium, ruthenium, and mixtures thereof and (ii) a mixed oxide composition comprising: a) about 1 to about 45 wt. % cerium on an oxide basis; b) about 40 to about 98 wt. % zirconium on an oxide basis; c) about 0.05 wt. % to about 0.50 wt. % iron on an oxide basis; d) about 0.015 wt. % to about 0.20 wt. % strontium on an oxide basis; and e) optionally an additional rare earth dopant selected from the group consisting of, lanthanum, neodymium, yttrium, praseodymium, samarium, gadolinium, and mixtures thereof, and when present each optional additional rare earth dopant is present in an amount of about 0.5 to about 15 wt. % on an oxide basis.

In certain embodiments, the suspension contains rhodium or palladium as the Platinum Group Metal (PGM). In further specific embodiments, the suspension comprises about 55 wt. % to about 65 wt % of the mixed oxide composition.

When the suspension as disclosed herein is dried and calcined, the dried and calcined suspension exhibits an improved Oxygen Storage Capacity (OSC), and in particular improved OSC at lower temperatures.

### BRIEF DESCRIPTION OF THE DRAWINGS

FIG. 1 is a graph of OSC (μmol/g) at temperatures of 300°-600° C. of the compositions of Examples 1-4, 5A, 5B, and 7 after aging at 1100° C./10H Air.

FIG. 2 is a graph of OSC (μmol/g) at temperatures of 350°-600° C. aged of the compositions of Examples 1-3 after aging at 1150° C./6H Air.

FIG. 3 is a graph of OSC (μmol/g) at temperatures of 350°-600° C. of the compositions of Examples 1, 4, and 6 after aging at 1100° C./10H Air.

FIG. 4 is a graph of BJH Pore Size Data of the compositions of Examples 1, 4, and 6.

FIG. 5 is a graph of OSC (μmol/g) at temperatures of 200°-450° C. of the compositions of Examples 10-12 (washcoat only) after aging at 1100° C./10H Air.

FIG. 6 is a graph of OSC (μmol/g) at temperatures of 200°-450° C. of the compositions of Examples 10-12 (mixed oxide composition+1.5 wt. % Pd) after aging at 1100° C./10H Air.

FIG. 7 is a graph of OSC (μmol/g) at temperatures of 200°-450° C. of the compositions of Examples 10-12 (mixed oxide composition+0.5 wt. % Rh) after aging at 1100° C./10H Air.

FIG. 8 is a graph of OSC (μmol/g) at temperatures of 200°-450° C. of the compositions of Examples 13-15 (mixed oxide composition+0.23 wt. % Rh) after aging at 1100° C./10H Air.

FIG. 9 are transmission electron microscopy (TEM) images of the composition of Example 2 aged at 1100° C./10H Air.

FIG. 10 is an x-ray powder diffraction (XRD) of the composition of Example 2 aged at 1100° C./10H Air as compared to a tetragonal ceria zirconia mixed oxide standard.

FIG. 11 are energy-dispersed x-ray spectroscopy (EDS) images of the composition of Example 2 aged at 1100° C./10H Air.

FIG. 12 are transmission electron microscopy (TEM) images of the composition of Example 5A aged at 1100° C./10H Air.

FIG. 13A is an x-ray powder diffraction (XRD) of the composition of Example 5A aged at 1100° C./10H Air as compared to a tetragonal ceria zirconia mixed oxide standard and perovskite LaFeO₃ (orthorhombic) standard.

FIG. 13B is an x-ray powder diffraction (XRD) of the composition of Example 5B aged at 1100° C./10H Air as compared to a tetragonal ceria zirconia mixed oxide standard and perovskite LaFeO₃ (orthorhombic) standard.

FIG. 14 are energy-dispersed x-ray spectroscopy (EDS) images of the composition of Example 5A aged at 1100° C./10H Air.

FIG. 15A is a graph of H₂-TPR results of slurries of Examples 1, 2, 4, and 6 as-prepared or “fresh.”

FIG. 15B is a graph of H₂-TPR results of slurries of Examples 1, 2, 4, and 6 after aging at 1100° C./4H Air.

FIG. 16 is a graph of OSC (μmol/g) at temperatures of 350°-600° C. of the compositions of Examples 1, 2, 4, and 6 after aging at 1100° C./10H Air.

FIG. 17 are x-ray powder diffraction (XRD) of the compositions of Examples 1, 2, 4, and 6 aged at 1000° C./10H Air (rich/lean aging) as compared to a tetragonal ceria zirconia mixed oxide standard and perovskite LaFeO₃ (orthorhombic) standard

### DETAILED DESCRIPTION

This disclosure generally relates to mixed oxide compositions containing cerium, zirconium, iron, strontium, and optionally additional rare earth dopant. This disclosure also relates to a suspension comprising platinum group metals (PGM) and the mixed oxide compositions described herein, as well as supported catalysts prepared from the described mixed oxides. The described mixed oxides are useful for treating exhaust gases from internal combustion engines and exhibit surprisingly enhanced low temperature oxygen storage capacity (OSC), even after aging at elevated temperatures.

Before the compositions, catalysts, and methods are disclosed and described in detail, it is to be understood that this disclosure is not limited to the particular structures, process steps, or materials disclosed herein, but is extended to equivalents thereof as would be recognized by those ordinarily skilled in the relevant arts. It should also be understood that terminology employed herein is used for the purpose of describing particular embodiments only and is not intended to be limiting. It must be noted that, as used in this specification, the singular forms “a,” “an,” and “the” include plural referents unless the context clearly dictates otherwise. Thus, for example, reference to “an additional rare earth dopant” is not to be taken as quantitatively or source limiting, reference to “a step” may include multiple steps, reference to “producing” or “products” of a reaction or treatment should not be taken to be all of the products of a reaction/treatment, and reference to “treating” may include reference to one or more of such treatment steps.

Numerical values with “about” or “approximately” include typical experimental variances. As used herein, the terms “about” and “approximately” are used interchangeably and mean within a statistically meaningful range of a value, such as a stated weight percentage, surface area, concentration range, time frame, temperature, pH, and the like. Such a range can be within 10%, and even more typically within 5% of the indicated value or range. Sometimes, such a range can be within the experimental error typical of standard methods used for the measurement and/or determination of a given value or range. The allowable variation encompassed by the term “about” will depend upon the particular system under study, and can be readily appreciated by one of ordinary skill in the art. Whenever a range is recited within this application, at least every whole number integer within the range is also contemplated as an embodiment of the invention.

The present disclosure relates to mixed oxide compositions having improved oxygen storage capacity (OSC), even after aging at elevated temperatures. These mixed oxide compositions are mixed oxides of cerium, zirconium, iron, and strontium. The mixed oxide compositions are in powder form. Within the mixed oxide composition, the individual components are intimately mixed.

As disclosed herein, these mixed oxide compositions importantly contain iron and strontium (as oxides) and this mixture of iron and strontium surprisingly provides the mixed oxide composition with improved OSC even after aging at elevated temperatures, in particular improved OSC at lower temperatures.

In certain embodiments, the mixed oxide compositions also contain an amount of additional rare earth dopant. This additional rare earth dopant can be selected from any of the rare earths or mixtures thereof. In certain embodiments, the additional rare earth dopant is selected from the group consisting of lanthanum, neodymium, yttrium, praseodymium, samarium, gadolinium, and mixtures thereof. In particular embodiments, the additional rare earth dopant is lanthanum, yttrium, or mixtures thereof.

The mixed oxide composition is described as a mixture of oxides of cerium, zirconium, iron, strontium, and optionally one or more additional rare earth dopants, and the amounts of these individual components are measured (and reported) as oxides. However, it is not excluded that any of these components may be present at least partly in the form of hydroxides, oxyhydroxides, carbonates, and/or oxycarbonates. The compositional proportions of these components are determined by a plasma torch analytical technique using optical emission spectroscopy, as described in greater detailed within the Examples section. This technique measures and reports the components by weight percent on an equivalent oxide basis with respect to the total weight of the mixed oxide composition. This technique provides accurate elemental analysis of the small, but important, amounts of iron and strontium present in the disclosed mixed oxide compositions as described herein.

These mixed oxide compositions as disclosed herein comprise about 1 to about 45 wt. % cerium on an oxide basis; about 40 to about 98 wt. % zirconium on an oxide basis; about 0.065 wt. % to about 0.75 wt. % iron on an oxide basis; about 0.015 wt. % to about 0.25 wt. % strontium on an oxide basis; and optionally an additional rare earth dopant. In certain embodiments, the mixed oxide compositions as disclosed herein comprise about 1 to about 45 wt. % cerium on an oxide basis; about 40 to about 98 wt. % zirconium on an oxide basis; about 0.05 wt. % to about 0.50 wt. % iron on an oxide basis; about 0.015 wt. % to about 0.20 wt. % strontium on an oxide basis; and optionally an additional rare earth dopant. When present, each additional rare earth dopant may be present in an amount of about 0.5 to about 15 wt. % on an oxide basis. In certain embodiments, the additional rare earth dopant is selected from the group consisting of lanthanum, neodymium, yttrium, praseodymium, samarium, gadolinium, and mixtures thereof.

In specific embodiments, the amounts of the individual components will vary so that the total amount is about 100% of the mixed oxide composition. It is important that the mixed oxide composition as disclosed herein contains the mixture of strontium and iron in the recited amounts.

Even though the amounts of iron and strontium are small, these small amounts impart surprisingly improved properties to the disclosed mixed oxide compositions. The mixture of iron and strontium surprisingly provides the mixed oxide composition with improved OSC even after aging at elevated temperatures, and in particular improved OSC at lower temperatures. These improved properties are provided when both strontium and iron are present and present in the recited amounts. Too much iron leads to formation of perovskite phase when aged at elevated temperatures and this acts as a sintering aid causing a mixed oxide composition containing a higher amount of iron to sinter. After sintering there is a loss of BET surface area and that begins to negatively impact OSC resulting in a non-linear OSC response in comparison to the mixed oxide compositions within the scope of this disclosure containing the disclosed mixture of SrO and Fe₂O₃. The amounts of iron and strontium may be adjusted within the range disclosed herein to achieve the desired properties and avoid formation of a perovskite phase.

The mixed oxide composition comprises the above-noted components within the amounts indicated, but in certain embodiments it also may comprise other elements and/or small amounts of impurities. In other embodiments, the mixed oxide composition consists essentially of the above-noted components and the amounts of the individual components will vary so that the total amount is about 100% of the mixed oxide composition.

The additional rare earth dopants can be selected from the group consisting of yttrium (Y), lanthanum (La), neodymium (Nd), praseodymium (Pr), samarium (Sm), europium (Eu), gadolinium (Gd), terbium (Tb), dysprosium (Dy), holmium (Ho), erbium (Er), thulium (Tm), ytterbium (Yb), lutetium (Lu), and mixtures thereof. In certain embodiments, the additional rare earth dopant is lanthanum, neodymium, yttrium, praseodymium, samarium, gadolinium, or mixtures thereof. In particular embodiments, the additional rare earth dopant is lanthanum, yttrium, or mixtures thereof. When present, each additional rare earth dopant may be present in an amount of about 0.5 to about 15 wt. % on an oxide basis. In certain embodiments, the mixed oxide composition contains an additional rare earth dopant in an amount of about 5 to about 15 wt. % on an oxide basis. In other embodiments, the mixed oxide composition contains about zero additional rare earth dopant.

The mixed oxide compositions may contain trace amounts of impurities. These impurities are typically present in an amount of about 1% by weight or less (to about zero or to an amount that is undetectable) based on the total weight of the mixed oxide composition. These impurities include residual solvents, salts, other metals, and the like. These other metals include those commonly found in water, such as magnesium, iron, calcium, silicon, sodium, and the like.

These impurity amounts (of about 1% by weight to about zero or to an amount that is undetectable) may be present in any of the described embodiments of the mixed oxide compositions. When present and detectable, any impurities may be present in an amount of about 100 ppm or less.

In one embodiment, the mixed oxide compositions as disclosed herein comprise a) about 30 to about 45 wt. % cerium on an oxide basis; b) about 40 to about 65 wt. % zirconium on an oxide basis; c) about 0.065 wt. % to about 0.75 wt. % iron on an oxide basis; d) about 0.015 wt. % to about 0.25 wt. % strontium on an oxide basis; and e) an additional rare earth dopant selected from the group consisting of lanthanum, yttrium, and mixtures thereof present in an amount of about 5 to about 15 wt. % on an oxide basis. In certain of these embodiments, the amounts of the individual components will vary so that the total amount is about 100% of the mixed oxide composition.

In another embodiment, the mixed oxide composition comprises a) about 30 to about 45 wt. % cerium on an oxide basis; b) about 40 to about 65 wt. % zirconium on an oxide basis; c) about 0.05 wt. % to about 0.50 wt. % iron on an oxide basis; d) about 0.015 wt. % to about 0.20 wt. % strontium on an oxide basis; and e) optionally an additional rare earth dopant selected from the group consisting of lanthanum, yttrium, and mixtures thereof present in an amount of about 5 to about 15 wt. % on an oxide basis. In certain of these embodiments, the amounts of the individual components will vary so that the total amount is about 100% of the mixed oxide composition.

In a specific embodiment, the mixed oxide compositions as disclosed herein comprise a) about 30 to about 45 wt. % cerium on an oxide basis; b) about 40 to about 65 wt. % zirconium on an oxide basis; c) about 0.05 wt. % to about 0.50 wt. % iron on an oxide basis; d) about 0.015 wt. % to about 0.20 wt. % strontium on an oxide basis; and e) an additional rare earth dopant selected from the group consisting of lanthanum, yttrium, and mixtures thereof present in an amount of about 5 to about 15 wt. % on an oxide basis. In certain of these embodiments, the amounts of the individual components will vary so that the total amount is about 100% of the mixed oxide composition.

In another embodiment, the mixed oxide compositions as disclosed herein comprise about 30 to about 45 wt. % cerium on an oxide basis, about 40 to about 65 wt. % zirconium on an oxide basis, about 0.1 wt. % to about 0.75 wt. % iron on an oxide basis, about 0.05 wt. % to about 0.25 wt. % strontium on an oxide basis, and optionally an additional rare earth dopant, with each optional additional rare earth dopant present in an amount of about 0.5 to about 15 wt. % on an oxide basis. In certain embodiments, when present, the total additional rare earth dopant is present in an amount of about 5 to about 15 wt. % on an oxide basis.

In another specific embodiment, the mixed oxide compositions as disclosed herein comprise about 30 to about 45 wt. % cerium on an oxide basis, about 40 to about 65 wt. % zirconium on an oxide basis, about 0.1 wt. % to about 0.50 wt. % iron on an oxide basis, about 0.05 wt. % to about 0.20 wt. % strontium on an oxide basis, and optionally an additional rare earth dopant, which when present is in an amount of about 5 to about 15 wt. % on an oxide basis.

In certain of these embodiments, the additional rare earth dopant is lanthanum, neodymium, yttrium, praseodymium, samarium, gadolinium, or mixtures thereof. In particular of these embodiments, the additional rare earth dopant is lanthanum, yttrium, or mixtures thereof. In certain of these embodiments, the mixed oxide composition contains the additional rare earth dopant in an amount of about 5 to about 15 wt. % on an oxide basis. And in other of these embodiments, the mixed oxide composition contains about zero additional rare earth dopant. In specific embodiments, the amounts of the individual components will vary so that the total amount is about 100% of the mixed oxide composition.

In further particular embodiments, the mixed oxide composition of the present disclosure consists essentially of CeO₂, ZrO₂, La₂O₃, Y₂O₃, Fe₂O₃, and SrO. In specific of these embodiments, the mixed oxide of the present disclosure consists essentially of CeO₂, ZrO₂, La₂O₃, Y₂O₃, Fe₂O₃, and SrO, wherein the ratio of Ce/Zr/La/Y/Sr/Fe is approximately 35 wt % to approximately 45 wt % cerium, approximately 45 wt % to approximately 55 wt % zirconium, approximately 3 wt % to approximately 6 wt % lanthanum, approximately 3 wt % to approximately 6 wt % yttrium, approximately 0.03 wt % to approximately 0.2 wt % strontium, and approximately 0.1 wt % to approximately 0.5 wt % iron on an oxide basis. In certain of these embodiments, the mixed oxide composition contains approximately 0.1 wt % to approximately 0.4 wt % iron on an oxide basis.

As described herein, the mixed oxide compositions containing both iron and strontium have improved OSC, even after aging at elevated temperatures, and in particular, surprisingly enhanced low temperature oxygen storage capacity (OSC). This improved or enhanced OSC is in comparison to a mixed oxide composition containing the same components (i.e., cerium, zirconium, and any optional rare earth dopants) in about the same constitutional amounts, except not containing strontium and iron, in which the amount of zirconium is varied to adjust for the absence of the strontium and iron. OSC is measured as described within the Examples.

After aging at 1100° C. for 10 hrs in air, the mixed oxide composition as disclosed herein may exhibit an Oxygen Storage Capacity (OSC) at about 200° C. to about 600° C. that is 2 to 8 times higher than an identical composition not containing a mixture of iron and strontium. In certain embodiments, after aging at 1100° C. for 10 hrs in air, the mixed oxide composition exhibits an Oxygen Storage Capacity (OSC) at about 250° C. to about 600° C. that is about 2 to about 8 times higher than an identical composition not containing a mixture of iron and strontium. In certain embodiments, after aging at 1100° C. for 10 hrs in air, the mixed oxide composition exhibits an Oxygen Storage Capacity (OSC) at about 250° C. to about 600° C. that is about 2 to about 7 times higher than an identical composition not containing a mixture of iron and strontium.

As defined above, “an identical composition not containing a mixture of iron and strontium” means a mixed oxide composition containing the same components (i.e., cerium, zirconium, and any optional rare earth dopants) in about the same constitutional amounts, except not containing strontium and iron, in which the amount of zirconium is varied to adjust for the absence of the strontium and iron.

In certain embodiments, after aging at 1100° C. for 10 hrs in air, the mixed oxide composition as disclosed herein may exhibit an Oxygen Storage Capacity (OSC) at about 250° C. to about 600° C. that is 2 to 4 times higher than an identical composition not containing a mixture of iron and strontium. As described, this improved OSC is particularly enhanced at low temperatures. As such, these improvements may be particularly evident at temperatures of about 200° C. to about 450° C. or at temperatures of about 250° C. to about 450° C.

In certain embodiments, after aging at 1150° C. for 6 hrs in air, the mixed oxide composition may exhibit an Oxygen Storage Capacity (OSC) at about 250° C. to about 600° C. that is 2 to 3 times higher than an identical composition not containing a mixture of iron and strontium. These improvements may be particularly evident at temperatures of about 200° C. to about 450° C. or at temperatures of about 250° C. to about 450° C.

Any of these improved OSC characteristics may be combined with one another and may be combined with any of the above-described embodiments of the mixed oxide compositions and/or with any of the below described properties.

The mixed oxide compositions also may exhibit other advantageous physical properties, both as prepared and after aging at elevated temperatures.

As described above, the mixed oxide compositions contain advantageously small amounts of iron and strontium, importantly such that after aging at elevated temperatures no perovskite phase is formed. As such, in certain embodiments, the mixed oxide composition exhibits no detectable perovskite or pyrochlore phases as determined by XRD after aging at 1100° C. for 10 hrs in air. The small amounts of iron and strontium may be varied such that after aging at elevated temperatures no perovskite phase is formed. The mixed oxide composition may exhibit a tetragonal phase or cubic phase as determined by XRD after aging at 1100° C. for 10 hrs in air.

In specific embodiments, the mixed oxide composition exhibits a tetragonal phase or cubic phase as determined by XRD after aging at 1150° C. for 6 hrs in air. The mixed oxide composition may exhibit no detectable perovskite or pyrochlore phases as determined by XRD after aging at 1150° C. for 6 hrs in air.

In specific embodiments, after aging at 1100° C. for 10 hrs in air, the mixed oxide compositions as disclosed herein may have a crystallite size of about 50 nm to about 100 nm.

Any of these crystalline phase embodiments may be combined and may be combined with any of the above-described embodiments of the mixed oxide compositions and/or with any of the below described properties.

As described herein formation of a detectable perovskite phase is undesirable. Too much iron (iron in amounts greater than in the presently disclosed mixed oxide composition) leads to formation of perovskite phase when aged at elevated temperatures and this acts as a sintering aid causing the mixed oxide composition to sinter. After sintering there is a loss of BET surface area that begins to negatively impact OSC. Any loss of OSC is undesirable and is avoided by the mixed oxide compositions as disclosed herein.

The mixed oxide compositions further may exhibit an advantageous BET surface area.

BET surface area is measured as described within the Examples. In certain embodiments, the mixed oxide compositions as disclosed herein exhibit a fresh BET surface area between about 40 and about 80 m²/g, and in certain embodiments, these mixed oxide compositions exhibit a fresh BET surface area of about 40 to about 50 m²/g. As described herein “fresh” means “as prepared” and is without any additional aging at elevated temperatures. In certain embodiments, the mixed oxide compositions exhibit a BET surface area of about 10 m²/g to about 20 m²/g when aged at 1100° C. for 10 hrs in air. In specific embodiments, the mixed oxide compositions exhibit a BET surface area of greater than about 2 m²/g to less than about 10 m²/g when aged at 1150° C. for 6 hrs in air. Despite the lower BET surface area after aging at 1150° C. for 6 hrs in air, OSC remains two to three times higher than identical compositions lacking SrO and Fe₂O₃.

Any of these BET surface areas embodiments may be combined and may be combined with any of the above-described embodiments of the mixed oxide compositions.

The mixed oxide compositions further may exhibit an advantageous particle size.

Particle size is measured as described within the Examples. In certain the mixed oxide compositions have a particle size characterized by a D₉₀ of about 6 μm to about 20 μm and a D₁₀ of about 1 μm to about 10 μm.

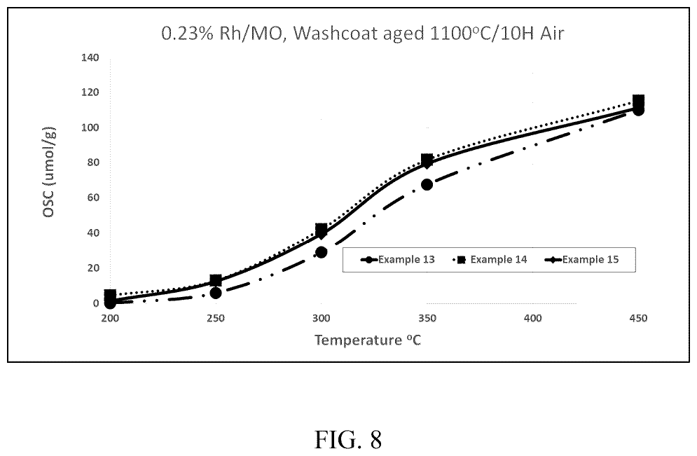

After at about 1100° C. for 4 hours in air, the mixed oxide compositions may have a H₂TPR (Hydrogen Temperature Programmed Reduction) exhibiting a single symmetrical reduction peak when aged at about 1100° C. for 4 hours in air. H₂TPR is measured as described within the Examples. The peak reduction temperature decreases as the mixture of iron oxide (Fe₂O₃) and strontium oxide (SrO) increases to within the amounts disclosed herein, which correlates with increased low temperature OSC performance, (see FIG. 8). It is noted that a lower peak reduction temperature corresponds to lower OSC light-off temperature and that correlates with improved OSC at lower temperatures.

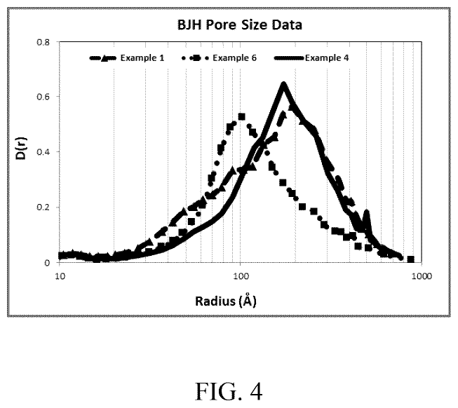

Pore size is an important physical characteristic of the mixed oxide compositions. Pore size is measured as described within the Examples. Pores allow for diffusion of low molecular weight and high molecular weight macromolecule gas phase reactants. The mixed oxide compositions may exhibit advantageous pore sizes as prepared (after the initial thermal treatment/calcination associated with the manufacturing process). In some embodiments, primary, secondary, tertiary, and quaternary ammonium hydroxides are used as precipitating agents in the preparation of the mixed oxide compositions to augment pore size. As shown in FIG. 4, the use of tetra methyl ammonium hydroxide (TMAOH) can impact pore size of the mixed oxide composition. Ammonium hydroxides can be used to augment pore size without negatively impacting other physical properties of the mixed oxide composition. Optimizing the pore size is important because the pore size needs to be sufficient for diffusion of the harmful gases, but not too large because pore size increases with high temperature aging.

Any of the above-described embodiments of the mixed oxide compositions may be used in a catalyst or catalyst composition as an initial feed material.

### Preparing the Mixed Oxide Compositions

The mixed oxide compositions as disclosed herein are made by methods as described in the appended Examples.

For example, in a first step a zirconium salt such as zirconium basic carbonate, a cerium compound (such as cerium hydroxide) or salts of cerium (such as cerium carbonate), and any optional additional rare earth dopant salts (such as yttrium carbonate) are dissolved in a mixture of deionized water and nitric acid. In the alternative soluble salts, such as nitrates or chlorides, can be utilized and dissolved directly in deionized water. The mixed rare earth zirconium nitrate solution is then precipitated with a mixture of deionized water, ammonium hydroxide, and lauric acid. The pH of this step is controlled to a pH of approximately 9 to approximately 11.

In a second step, any additional rare earth dopant salt (such as lanthanum carbonate) is dissolved with iron nitrate and strontium nitrate in nitric acid and deionized water. This mixture is added to the precipitate from the first step with pH controlled between approximately 9 and 11. The mixture is continuously mixed. A precipitate is formed and then filtered and washed.

The isolated precipitate is calcined/thermally treated at about 750° C. to about 1000° C. for about 4 hours to about 8 hours at temperature. In certain embodiments, the isolated precipitate is calcined/thermally treated at about 850° C. to about 1050° C. or at about 950±50° C.

The calcined material can be milled to a particular particle size if desired.

Further details of the preparation of the mixed oxide compositions are described in Examples 1-7 below.

### Washcoat Compositions and Preparation Thereof

Also disclosed herein are washcoat suspension composition for use as a component of a catalytic coating and preparation of these washcoat compositions. The washcoats are applied as a catalyst coating to a catalyst support. The washcoats as disclosed herein are applied to a substrate from a suspension, and then dried and thermally treated/calcined. The suspension also may be described as a slurry and these two terms are used interchangeably. After application to a support, the suspension is dried and calcined to create a dried and calcined washcoat powder.

This dried and calcined catalytic washcoat powder and the composite support (or substrate) can be referred to as a coated catalyst article, which once assembled or canned becomes a catalytic converter. This dried and calcined washcoat powder has improved tablOSC even after aging at elevated temperatures, in particular improved OSC at lower temperatures.

As disclosed herein, the washcoat suspension comprises: (i) a Platinum Group Metal (PGM) selected from group consisting of platinum, palladium, rhodium, iridium, osmium, ruthenium, and mixtures thereof and (ii) the mixed oxide compositions as disclosed herein. In some embodiments, the suspension can contain about 55 wt. % to about 65 wt % of the mixed oxide composition. These mixed oxide compositions include all of the embodiments of the mixed oxide compositions as described herein. As such, the mixed oxide compositions can comprise a) about 1 to about 45 wt. % cerium on an oxide basis; b) about 40 to about 98 wt. % zirconium on an oxide basis; c) about 0.065 wt. % to about 0.75 wt. % iron on an oxide basis; d) about 0.015 wt. % to about 0.25 wt. % strontium on an oxide basis; and e) optionally an additional rare earth dopant. In certain embodiments, the mixed oxide compositions can comprise a) about 1 to about 45 wt. % cerium on an oxide basis; b) about 40 to about 98 wt. % zirconium on an oxide basis; c) about 0.05 wt. % to about 0.50 wt. % iron on an oxide basis; d) about 0.015 wt. % to about 0.20 wt. % strontium on an oxide basis; and e) optionally an additional rare earth dopant.

The additional rare earth dopant can be any rare earth or a mixture thereof. In certain embodiments, the additional rare earth dopant selected from the group consisting of, lanthanum, neodymium, yttrium, praseodymium, samarium, gadolinium, and mixtures thereof. When present each optional additional rare earth dopant is present in an amount of about 0.5 to about 15 wt. % on an oxide basis. In specific embodiments, the amounts of the individual components will vary so that the total amount is about 100% of the mixed oxide composition.

It is noted that the washcoat suspensions include all of the mixed oxide compositions as disclosed herein and including all of the properties/characteristics as disclosed herein for the mixed oxide compositions.

In an embodiment, the washcoat suspensions include (i) a Platinum Group Metal (PGM) selected from group consisting of platinum, palladium, rhodium, mixtures thereof, and (ii) a mixed oxide composition comprising a) about 30 to about 45 wt. % cerium on an oxide basis; b) about 40 to about 65 wt. % zirconium on an oxide basis; c) additional rare earth dopant selected from the group consisting of lanthanum, yttrium, and mixtures thereof present in an amount of about 5 to about 15 wt. % on an oxide basis; and d) a mixture of iron and strontium, wherein the iron is present in an amount of about 0.1 wt. % to about 0.75 wt. % on an oxide basis and the strontium is present in an amount of about 0.05 wt. % to about 0.25 wt. % on an oxide basis. In specific of these embodiments, the amounts of the individual components will vary so that the total amount is about 100% of the mixed oxide composition.

In certain embodiments, the washcoat suspensions include (i) a Platinum Group Metal (PGM) selected from group consisting of platinum, palladium, rhodium, mixtures thereof, and (ii) a mixed oxide composition comprising a) about 30 to about 45 wt. % cerium on an oxide basis; b) about 40 to about 65 wt. % zirconium on an oxide basis; c) additional rare earth dopant selected from the group consisting of lanthanum, yttrium, and mixtures thereof present in an amount of about 5 to about 15 wt. % on an oxide basis; and d) a mixture of iron and strontium, wherein the iron is present in an amount of about 0.1 wt. % to about 0.50 wt. % on an oxide basis and the strontium is present in an amount of about 0.05 wt. % to about 0.20 wt. % on an oxide basis. In specific of these embodiments, the amounts of the individual components will vary so that the total amount is about 100% of the mixed oxide composition.

In certain embodiments, the Platinum Group Metal (PGM) used in the washcoat suspension is rhodium or palladium, and in particular embodiments, the PGM is rhodium. In other embodiments, the PGM used in the washcoat suspension is palladium.

In embodiments in which the washcoat suspension composition contains rhodium, the suspension may comprise about 0.2 wt. % to about 0.50 wt. % rhodium as metal dispersed on a mixed oxide basis. In embodiments in which the washcoat suspension contains palladium, the suspension may comprise about 0.5 wt % to about 1.50 wt % palladium as metal dispersed on a mixed oxide basis.

The washcoat slurries as disclosed herein are prepared by adding the mixed oxide composition, an aluminum oxide (Al₂O₃), an insoluble alkaline earth (AE) salt, and a pseudoboehmite binder to deionized water. In certain embodiments, the aluminum oxide can be a La₂O₃ doped Al₂O₃. The deionized water also may contain a carboxylic acid and in certain embodiments, the carboxylic acid can be acetic acid. The carboxylic acid in the suspension can be utilized to adjust the pH of the suspension to about 4 to about 6. In certain embodiments, the deionized water further may contain sucrose. The final slurry has low nitric acid content.

The insoluble alkaline earth (AE) salt is used as a washcoat stabilizing agent and pore forming agent. In certain embodiments, the insoluble alkaline earth is barium sulfate (BaSO₄), which minimizes solubility/interactions with the mixed oxide composition during the preparation of the washcoat slurry composition and is known to create porosity at elevated temperatures once in service.

As such, the washcoat slurry as described herein may contain one or more of La₂O₃ doped Al₂O₃, BaSO₄, a pseudoboehmite binder, a carboxylic acid (such as acetic acid), and/or sucrose. In certain embodiments, the washcoat slurry has a solids content of about 40% by weight to about 50% by weight when dried and calcined at about 1000*50° C.

In some embodiments, the catalytic washcoat is prepared and the Platinum Group Metal (PGM) is added after the base slurry is prepared to minimize interactions with the mixed oxide composition. In some embodiments, the Platinum Group Metal (PGM) is selected from the group consisting of platinum, palladium, rhodium, iridium, osmium, ruthenium, as single metals, and as mixtures thereof, and in certain of these embodiments is palladium, rhodium, or a mixture thereof. The Platinum Group Metal (PGM) can be added to the base slurry as nitrate solutions prepared from nitrate salts of the Platinum Group Metal (PGM).

After the washcoat slurry compositions are prepared, these slurry compositions are dried/calcined at about 500° C. to about 600° C. for about 45 mins to about 3 hours.

The dried and calcined powders have improved OSC, even after aging at elevated temperatures, and in particular, surprisingly enhanced low temperature oxygen storage capacity (OSC). These improvements may be particularly evident at temperatures of about 250° C. to about 450° C. The dried and calcined powders exhibit an improved Oxygen Storage Capacity (OSC) at about 250° C. to about 600° C. in comparison to a dried and calcined suspension containing a mixed oxide composition with an identical composition but not containing the mixture of iron and strontium. In certain embodiments, this improvement can be particularly evident when the dried slurry powders contain rhodium as the Platinum Group Metal (PGM).

The mixed oxide compositions and slurry compositions as described herein are further characterized by and described in the following examples. These Examples also provide details on the techniques for measuring the physical characteristics of the mixed oxide compositions. However, the Examples are in no way limiting of the compositions as described herein.

Further details of the preparation of the washcoat suspensions are described in Examples 10-15 below.

### EXAMPLES

OSC Measurements: OSC measurements were obtained under the following conditions. Powder samples were aged/heated under targeted conditions. 1100° C./10H Air and 1150° C./6H Air were used for data in Tables 2, 3, 4 and 7. For measurement of OSC, an O₂ pulse chemisorption method was utilized with OSC measurements made at the desired temperatures. Examples include, but are not limited to, 200° C., 300° C., 350° C., 450° C., and 600° C. For instance, for OSC measurements at 350° C., characterization was performed in a Micrometrics Autochem 2920 system, where 0.1 g of the samples were weighed into a quartz sample tube with a packed quartz wool bed. The samples were then subjected to pre-treatment in which the temperature was first raised to 350° C. under the flow of 50 cm³/min He gas, then subjected to ten-time pulse application of 10% O₂/He, followed by another twenty-time pulse application of 10% CO/He while being kept at the targeted temperature. Thereafter, the samples were subjected to pulse application of 10% O₂/He until saturation was reached and the oxygen storage capacity was measured by the cumulative quantity of O₂ absorbed at 350° C.

Compositional Content: ICP-OES (Inductively Coupled Plasma Optical Emission spectroscopy) manufactured by Agilent, Model #Agilent ICP-OES 5110 is used to provide accurate elemental analysis of the major components (e.g. Ce, Zr, La and Y), works by introducing the sample into a high temperature plasma to ionize and excite its atoms. As the excited species return into their ground state, they emit characteristic wavelengths of light, which are then dispersed and detected to create a spectrum. This allows for the identification and quantification of elements based on their unique wavelengths. The sample is first dissolved in acid to release the elements of interest, then atomized in the atomization chamber to form a fine aerosol and introduced into a plasma rectangular tube. This causes the sample to be directly excited by the argon plasma light source for spectroscopic determination, and the results are normalized. Calibration standards help relate intensity to concentration. AAS (Atomic Absorption Spectroscopy) manufactured by Agilent, Model #Agilent AAS 200 Series AA. This technique, which is used to provide accurate elemental analysis of Fe and Sr, works by introducing the sample into a flame to convert it into a fine aerosol. Next, a hollow cathode lamp is used to emit light at wavelengths corresponding to the absorption lines of the element of interest. At specific wavelengths, the atoms absorb the emitted light, and the amount of absorbed light is measured by a detector. The sample is first dissolved in acid to release the elements of interest. Strontium oxide and iron oxide are each measured by the standard curve method using a specific lamb plugged into the atomic absorption instrument then ionized in an air-acetylene flame aspirated as the dilute sample/acid medium. The decrease in intensity is proportional to the concentration of the element in the sample.

SEM Method: Scanning Electron Microscopy images were obtained using a JEOL model #JSM-6010LV with the powder sample being analyzed attached onto a sample stub via carbon tape. Scanning electron microscope (SEM) produced images of a sample by raster scanning the surface with a beam of high-energy electrons. Magnets focus the electron beam to a point several nanometers in diameter. As the electrons interact with atoms in the sample, various signals are produced and compiled by various imaging and analytical detectors. Generally, secondary electrons emitted by atoms excited by the electron beam are detected by a secondary electron detector to reveal surface topography.

SEM-EDS Method: For SEM energy-dispersed x-ray spectroscopy (EDS), the instrument used was manufactured by Oxford Instruments Model #x-act (10 mm² Silicon Drift Detector). Sample preparation was the same as an SEM sample; powdered sample was attached onto a sample stub via carbon tape. Energy dispersive spectroscopy (EDS) makes use of the characteristic X-rays that are emitted from the sample during SEM imaging. These X-rays are emitted when outer shell electrons replace inner shell electrons which are displaced by the high-energy SEM electron beam. Because each element has a unique energy difference between outer and inner electron shells, characteristic X-rays are detected at specific energies and can be correlated with an elemental identification. A silicon drift detector (SDD) is the most common type of EDS detector used in a SEM instrument.

TEM-EDS Method: For transmission electronic microscopy EDS, the instrument used was manufactured by Thermofisher, Model #Thermofisher Talos F200X TEM with Super-X SDD detector. Transmission electron microscope (TEM) uses electron beams transmitted through a thin specimen to obtain high resolution images of its internal structure. It is often coupled with EDS technique to analyze the X-ray generated when the specimen is bombarded with electrons and provide information about the elemental composition of the sample. To prepare ultra-thin specimens (typically less than 100 nm) for electron transmission, the FIB technique is used to precisely mill and remove the material at the nanoscale with a beam of focused ion (typically gallium ions). The TEM sample was prepared by focus ion beam (FIB, Thermofisher Helios G4 UX) at 30 keV, and the final FIB cleaning of TEM lamella was performed at 5 keV to minimize the surface amorphization of the thin lamella.

XRD Method: For x-ray diffraction (XRD), the following method was used. The instrument used was manufactured by Malvern Panalytical Model #Empyrean Multipurpose X-ray diffractometer. Powder sample (1-2 g) was prepared by packing and flattening (by using a glass slide) the material being analyzed on a shallow-well sample holder. X-ray diffraction (XRD) is the result of constructive interference between X-rays and a crystalline sample. The wavelength of the X-rays used is of the same order of magnitude of the distance between the atoms in a crystalline lattice. This gives rise to a diffraction pattern that can be analyzed in several ways, the most popular being applying the famous Bragg's Law (nλ=2d sin θ) which is used in the measurement of crystals and their phases. A scan speed of 0.001395°/s and a step size of 0.0393908° was employed.

BET SA using N₂ and BJH Pore Size/Radius and Pore Volume Method: This method was used to obtain BET (Brunauer, Emmett and Teller) Surface area (SA) and BJH (Barrett, Joyner, and Halenda) Pore Radius (PR) and Pore Volume (PV) data. The instrument used is the Micromeritics Model #ASAP 2460 Surface Area and Porosimetry Analyzer. To prepare a powder sample for analysis, the sample is first degassed at 350° C. for 2 hours. The technique involves exposing the material to N₂ gas and measuring the amount of N₂ gas adsorbed at different pressures. The BET theory, which is applied to determine the specific surface area of the material, relates to the amount of gas adsorbed at a given pressure to the monolayer coverage of N₂ adsorbate on the surface. The BJH theory, which is applied to determine the pore volume and pore size distribution, analyzes the desorption isotherms over the range of relative pressures where the desorption occurs.

H₂TPR Method: The following method was used to obtain H₂TPR data. The instrument used was the Micrometrics Autochem H 2920 Automated Catalyst Characterization System. All samples analyzed were aged/heated at 1100° C./4H in Air. The gas used was 5% H₂ in Argon, temperature program: ramping up to 1000° C. (ramp rate: 13° C./min). The reduction was repeated for two cycles, sample was oxidized before the second cycle.

Particle Size Method: Particle sizes were measured by laser using a Malvern Mastersizer. Particle size distribution does not require wet milling, thus reducing mechanical and chemical exposure during washcoat preparation stage. Additionally, dry milling reduces chemical attack caused by mechanical wet milling at elevated temperatures.

Catalytic Washcoat Simulation Test Method: Using a wire-wound rod with 1.0 mm spacing, a bead of slurry was placed on a smooth soda-lime glass sheet. The slurry was quickly drawn down evenly to produce a thin film ca. 25 μm (microns) thick. The glass plate was then quickly inserted into a drying oven controlling to 150° C. for 20 minutes to produce a dried film. The film was scraped off with a plastic spoon and collected for calcination at 550° C. for 2 hours. The calcined slurry powder was used for subsequent thermal aging studies (e.g., 1100° C. for 10 hours). This method simulates fast drying of a catalytic washcoat slurry. Slurry properties, physical properties and resulting OSC measurements can be found in Tables 5, 6, and 7 respectively, which are described in the Examples below.

### Mixed Oxide Composition Examples:

### Comparative Example 1: Preparation of Ceria Zirconia Composition

A 6.0 Kg batch of Ceria Zirconia with targeted composition, 40/50/5/5 CeO₂/ZrO₂/La₂O₃/Y₂O₃ was made by first dissolving 7.500 Kg ZBC (Zirconium basic carbonate), 3.636 Kg Ce(OH)₄ (Cerium IV hydroxide), 0.545 Kg La₂(CO₃)₃ (Lanthanum carbonate), and 0.475 Kg Y₂(CO₃)₃ (Yttrium carbonate) in a mixture of 28 L DI H₂O (deionized water) and 15 L 8M HNO₃ (Nitric acid). The mixed rare earth zirconium nitrate solution was then precipitated with a mixture of 63 L DI H₂O (deionized water), 31.5 L NH₄OH (Ammonium hydroxide, 25% NH₃ water) and 3.0 Kg C₁₂H₂₄O₂(Lauric acid). The final pH was controlled between 9.5 and 10.0. Continuous mixing was employed throughout. The final precipitate was then filtered, washed, and calcined (calcined or calcination refers to the heat treatment during manufacturing) to 750° C. to 1000° C., with 950±50° C. preferred. The material was then milled to final particle size D90≤20 μm.

Further details are described in the Summary of Examples 1-7 below.

### Example 2: Preparation of Ceria Zirconia Composition Including SrO and Fe₂O₃

A 6.0 Kg batch of Ceria Zirconia with targeted composition, 40/49.56/5/5/0.09/0.35 CeO₂/ZrO₂/La₂O₃/Y₂O₃/SrO/Fe₂O₃ was made by first dissolving 7.434 Kg ZBC (Zirconium basic carbonate), 3.636 Kg Ce(OH)₄ (Cerium IV hydroxide) and 0.475 Kg Y₂(CO₃)₃ (Yttrium carbonate) in a mixture of 28 L DI H₂O (deionized water) and 15 L 8M HNO₃ (Nitric acid). The mixed rare earth zirconium nitrate solution was then precipitated with a mixture of 63 L DI H₂O (deionized water), 31.5 L NH₄OH (Ammonium hydroxide, 25% NH₃ water) and 3.0 Kg C₁₂H₂₄O₂(Lauric acid). The final pH of step 1 was controlled between 9.5 and 10.0.

As a second step, a mixture of 0.545 Kg La₂(CO₃)₃ (Lanthanum carbonate), 0.011 Kg Sr(NO₃)₂ (Strontium nitrate) and 0.106 Kg Fe(NO₃)_{3.9}H₂O (Iron(III) Nitrate Nonahydrate) dissolved in 1.0 L 8M HNO₃ (Nitric acid) and 2.6 L DI H₂O (deionized water) was added to the precipitate from the first step with final pH controlled between 9.5 and 10.0. Continuous mixing was employed throughout. The resulting final precipitate was then filtered, washed and calcined to 750° C. to 1000° C., with 950±50° C. preferred. The material was then milled to final particle size D90≤20 μm.

Further details are described in the Summary of Examples 1-7 below.

### Comparative Example 3: Preparation of Ceria Zirconia Composition Including Fe₂O₃ but No SrO

A 6.0 Kg batch of Ceria Zirconia with targeted composition, 40/49.67/5/5/0.33 CeO₂/ZrO₂/La₂O₃/Y₂O₃/Fe₂O₃ was made by first dissolving 7.451 Kg ZBC (Zirconium basic carbonate), 3.636 Kg Ce(OH)₄ (Cerium IV hydroxide) and 0.475 Kg Y₂(CO₃)₃ (Yttrium carbonate) in a mixture of 28 L DI H₂O (deionized water) and 15 L 8M HNO₃ (Nitric acid). The mixed rare earth zirconium nitrate solution was then precipitated with a mixture of 63 L DI H₂O (deionized water), 31.5 L NH₄OH (Ammonium hydroxide, 25% NH₃ water) and 3.0 Kg C₁₂H₂₄O₂(Lauric acid). The final pH of step 1 was controlled between 9.5 and 10.0.

As a second step, a mixture of 0.545 Kg La₂(CO₃)₃ (Lanthanum carbonate) and 0.100 Kg Fe(NO₃)_{3.9}H₂O (Iron(III) Nitrate Nonahydrate) dissolved in 1.0 L 8M HNO₃ (Nitric acid) and 2.6 L DI H₂O (deionized water) was added to the precipitate from the first step with final pH controlled between 9.5 and 10.0. Continuous mixing was employed throughout. The final precipitate was then filtered, washed and calcined to 750° C. to 1000° C., with 950±50° C. preferred. The material was then milled to final particle size D90≤20 μm.

Further details are described in the Summary of Examples 1-7 below.

### Example 4: Preparation of Ceria Zirconia Composition Including SrO and Fe₂O₃

A 6.0 Kg batch of Ceria Zirconia with targeted composition, 40/49.79/5/5/0.04/0.17 CeO₂/ZrO₂/La₂O₃/Y₂O₃/SrO/Fe₂O₃ was made by first dissolving 7.469 Kg ZBC (Zirconium basic carbonate), 3.636 Kg Ce(OH)₄ (Cerium IV hydroxide) and 0.475 Kg Y₂(CO₃)₃ (Yttrium carbonate) in a mixture of 28 L DI H₂O (deionized water) and 15 L 8M HNO₃ (Nitric acid). The mixed rare earth zirconium nitrate solution was then precipitated with a mixture of 63 L DI H₂O (deionized water), 31.5 L NH₄OH (Ammonium hydroxide, 25% NH₃ water) and 3.0 Kg C₁₂H₂₄O₂(Lauric acid). The final pH of step 1 was controlled between 9.5 and 10.0.

As a second step, a mixture of 0.545 Kg La₂(CO₃)₃ (Lanthanum carbonate), 0.005 Kg Sr(NO₃)₂ (Strontium nitrate) and 0.052 Kg Fe(NO₃)_{3.9}H₂O (Iron(III) Nitrate Nonahydrate) dissolved in 1.0 L 8M HNO₃ (Nitric acid) and 2.6 L DI H₂O (deionized water) was added to the precipitate from the first step with final pH controlled between 9.5 and 10.0. Continuous mixing was employed throughout. The final precipitate was then filtered, washed and calcined to 750° C. to 1000° C., with 950±50° C. preferred. The material was then milled to final particle size D90≤20 μm.

Further details are described in the Summary of Examples 1-7 below.

### Comparative Example 5A: Preparation of Ceria Zirconia Composition Including SrO and Higher Amount of Fe₂O₃

A 6.0 Kg batch of Ceria Zirconia with targeted composition, 40/47.82/5/5/0.45/1.73 CeO₂/ZrO₂/La₂O₃/Y₂O₃/SrO/Fe₂O₃ was made by first dissolving 7.173 Kg ZBC (Zirconium basic carbonate), 3.636 Kg Ce(OH)₄ (Cerium IV hydroxide) and 0.475 Kg Y₂(CO₃)₃ (Yttrium carbonate) in a mixture of 28 L DI H₂O (deionized water) and 15 L 8M HNO₃ (Nitric acid). The mixed rare earth zirconium nitrate solution was then precipitated with a mixture of 63 L DI H₂O (deionized water), 31.5 L NH₄OH (Ammonium hydroxide, 25% NH₃ water) and 3.0 Kg C₁₂H₂₄O₂(Lauric acid). The final pH of step 1 was controlled between 9.5 and 10.0.

As a second step, a mixture of 0.545 Kg La₂(CO₃)₃ (Lanthanum carbonate), 0.055 Kg Sr(NO₃)₂ (Strontium nitrate) and 0.525 Kg Fe(NO₃)_{3.9}H₂O (Iron(III) Nitrate Nonahydrate) dissolved in 1.1 L 8M HNO₃ (Nitric acid) and 2.6 L DI H₂O (deionized water) was added to the precipitate from the first step with final pH controlled between 9.5 and 10.0. Continuous mixing was employed throughout. The final precipitate was then filtered, washed and calcined to 750° C. to 1000° C., with 950±50° C. preferred. The material was then milled to final particle size D90≤20 μm.

### Example 5B: Preparation of Ceria Zirconia Composition Including SrO and Higher Amount of Fe₂O₃

A 6.0 Kg batch of Ceria Zirconia with targeted composition, 40/49.12/5/5/0.18/0.70 CeO₂/ZrO₂/La₂O₃/Y₂O₃/SrO/Fe₂O₃ was made by first dissolving 7.368 Kg ZBC (Zirconium basic carbonate), 3.636 Kg Ce(OH)₄ (Cerium IV hydroxide) and 0.475 Kg Y₂(CO₃)₃ (Yttrium carbonate) in a mixture of 28 L DI H₂O (deionized water) and 15 L 8M HNO₃ (Nitric acid). The mixed rare earth zirconium nitrate solution was then precipitated with a mixture of 63 L DI H₂O (deionized water), 31.5 L NH₄OH (Ammonium hydroxide, 25% NH₃ water) and 3.0 Kg C₁₂H₂₄O₂(Lauric acid). The final pH of step 1 was controlled between 9.5 and 10.0.

As a second step, a mixture of 0.545 Kg La₂(CO₃)₃ (Lanthanum carbonate), 0.022 Kg Sr(NO₃)₂ (Strontium nitrate) and 0.213 Kg Fe(NO₃)_{3.9}H₂O (Iron(III) Nitrate Nonahydrate) dissolved in 1.0 L 8M HNO₃ (Nitric acid) and 2.6 L DI H₂O (deionized water) was added to the precipitate from the first step with final pH controlled between 9.5 and 10.0. Continuous mixing was employed throughout. The final precipitate was then filtered, washed and calcined to 750° C. to 1000° C., with 950±50° C. preferred. The material was then milled to final particle size D90≤20 μm.

Further details are described in the Summary of Examples 1-7 below.

### Example 6: Preparation of Ceria Zirconia Composition Including SrO and Fe₂O₃

A 6.0 Kg batch of Ceria Zirconia with targeted composition, 40/49.79/5/5/0.04/0.17 CeO₂/ZrO₂/La₂O₃/Y₂O₃/SrO/Fe₂O₃ was made by first dissolving 7.469 Kg ZBC (Zirconium basic carbonate), 3.636 Kg Ce(OH)₄ (Cerium IV hydroxide) and 0.475 Kg Y₂(CO₃)₃ (Yttrium carbonate) in a mixture of 28 L DI H₂O (deionized water) and 15 L 8M HNO₃ (Nitric acid). The mixture was then heated to 50° C. The mixed rare earth zirconium nitrate solution was then precipitated with a mixture of 100 L DI H₂O (deionized water), 5.3 Kg TMAOH (Tetra methyl ammonium hydroxide, 97%) and 3.0 Kg C₁₂H₂₄O₂(Lauric acid), which was preheated to 50° C. The final pH of step 1 was controlled between 9.5 and 10.0.

As a second step, a mixture of 0.545 Kg La₂(CO₃)₃ (Lanthanum carbonate), 0.005 Kg Sr(NO₃)₂ (Strontium nitrate) and 0.052 Kg Fe(NO₃)_{3.9}H₂O (Iron(III) Nitrate Nonahydrate) dissolved in 1.0 L 8M HNO₃ (Nitric acid) and 2.6 L DI H₂O (deionized water) was added to the precipitate from the first step with final pH controlled between 9.5 and 10.0. Continuous mixing was employed throughout. The final precipitate was then filtered, washed and calcined to 750° C. to 1000° C., with 950±50° C. preferred. The material was then milled to final particle size D90≤20 μm.

Further details are described in the Summary of Examples 1-7 below.

### Example 7: Preparation of Ceria Zirconia Composition Including Lower Amounts of SrO and Fe₂O₃

A 6.0 Kg batch of Ceria Zirconia with targeted composition, 40/49.87/5/5/0.03/0.10 CeO₂/ZrO₂/La₂O₃/Y₂O₃/SrO/Fe₂O₃ was made by first dissolving 7.481 Kg ZBC (Zirconium basic carbonate), 3.637 Kg (NH₄)₂[Ce(NO₃)₆](Ammonium Cerium Nitrate) and 28 L DI H₂O (deionized water) and 10 L 8M HNO₃ (Nitric acid) and heating for 1 h @55-65° C.

As a second step, a mixture of 0.545 Kg La₂(CO₃)₃ (Lanthanum carbonate), 0.475 Kg Y₂(CO₃)₃ (Yttrium carbonate), 0.0032 Kg Sr(NO₃)₂ (Strontium nitrate) and 0.0308 Kg Fe(NO₃)_{3.9}H₂O (Iron(III) Nitrate Nonahydrate) dissolved in 5.0 L 8M HNO₃ (Nitric acid) and 2.6 L DI H₂O (deionized water) was added to the first step. The mixed rare earth zirconium nitrate solution was then precipitated with a mixture of 63 L DI H₂O (deionized water), 31.5 L NH₄OH (Ammonium hydroxide, 25% NH₃ water) and 3.0 Kg C₁₂H₂₄O₂(Laurie acid). The final pH was controlled between 9.5 and 10.0. Continuous mixing was employed throughout. The final precipitate was then filtered, washed and calcined to 750° C. to 1000° C., with 950±50° C. preferred. The material was then milled to final particle size D90≤20 μm.

Further details are described in the Summary of Examples 1-7 below.

### Summary: Characterization of the Compositions of Examples 1-7

The compositions of Examples 1-7 were characterized as described below. Data and compositional analyses are also provided.

The compositional content of the compositions of Examples 1-7 were measured by ICP spectroscopy. After aging at 1000° C./10H air, the compositions were analyzed by XRD, and the BET surface area was measured for the as-prepared compositions (i.e., fresh) and after aging/heating at 1100° C./10H air and 1100° C./10H air. This additional aging (heat) treatment is performed at for the specified time and temperature in the specified atmosphere. Particle size also was measured. Table 1 below summarizes these results.

TABLE 1

| | | | | | | | | | SA BET Method (m²/g) | | |
|---|---|---|---|---|---|---|---|---|---|---|---|
| | XRD Phases | | | | | | | | | 1000° C./ | 1100° C./ |
| | 1100° C./ | Composition | | | | | | D90 | | 10 h | 10 h |
| Designation | 10 h Air | CeO₂ | ZrO₂ | La₂O₃ | Y₂O₃ | SrO | Fe₂O₃ | (μm) | Fresh | Air | Air |
| Example 1 | Ce_{0.5}Zr_{0.5}O₂ | 40.05 | 50.24 | 4.83 | 4.88 | — | — | 8.68 | 72.7 | 40.0 | 25.1 |
| | Tetragonal | | | | | | | | | | |
| Example 2 | Ce_{0.5}Zr_{0.5}O₂ | 40.98 | 49.36 | 4.41 | 4.89 | 0.07 | 0.29 | 10.62 | 61.5 | 41.3 | 10.0 |
| | Tetragonal | | | | | | | | | | |
| Example 3 | Ce_{0.5}Zr_{0.5}O₂ | 40.62 | 49.82 | 4.28 | 5.00 | — | 0.28 | 13.96 | 47.5 | 30.6 | 12.3 |
| | Tetragonal | | | | | | | | | | |
| Example 4 | Ce_{0.5}Zr_{0.5}O₂ | 40.72 | 49.96 | 4.16 | 4.97 | 0.04 | 0.15 | 8.68 | 56.4 | 34.8 | 16.0 |
| | Tetragonal | | | | | | | | | | |
| Example 5A | Ce_{0.5}Zr_{0.5}O₂ | 40.84 | 47.86 | 4.65 | 4.88 | 0.33 | 1.44 | 11.05 | 52.3 | 9.8 | 1.8 |
| | LaFeO₃ | | | | | | | | | | |
| | Orthorhombic | | | | | | | | | | |
| Example 5B | Ce_{0.5}Zr_{0.5}O₂ | 40.28 | 49.32 | 4.79 | 4.83 | 0.15 | 0.63 | 15.69 | 49.2 | 30.3 | 3.0 |
| | LaFeO₃ | | | | | | | | | | |
| | Orthorhombic | | | | | | | | | | |
| Example 7 | Ce_{0.5}Zr_{0.5}O₂ | 40.40 | 49.58 | 5.00 | 4.90 | 0.028 | 0.09 | 11.83 | 58.1 | 40.7 | 22.3 |
| | Tetragonal | | | | | | | | | | |

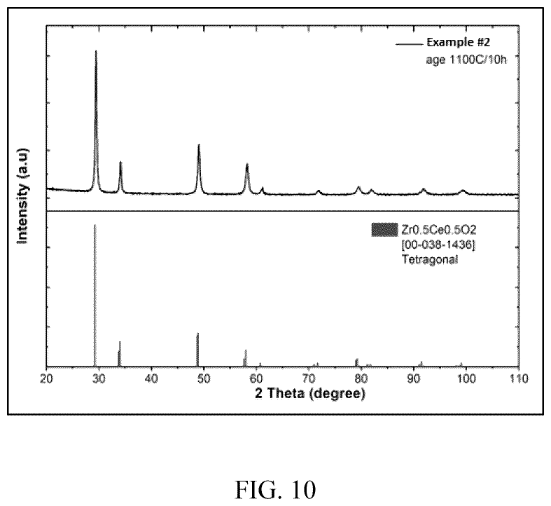

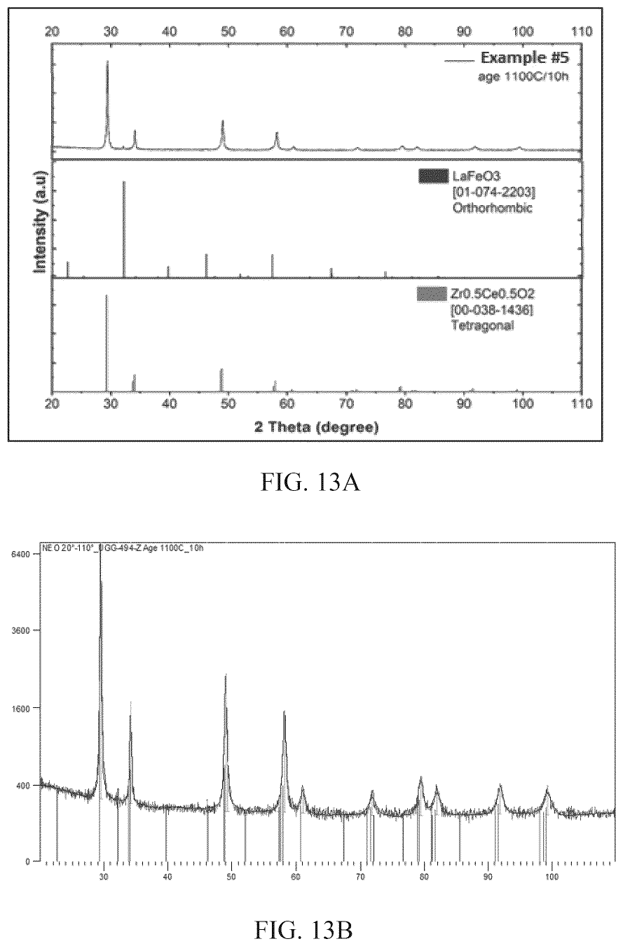

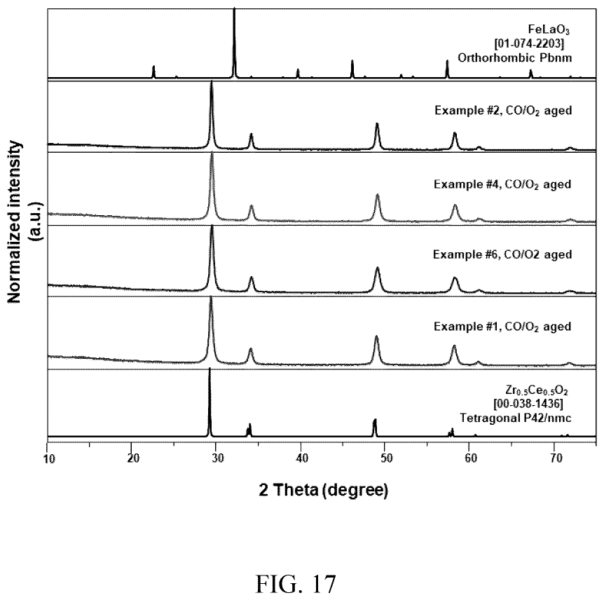

The compositional analyses confirm that the amounts of CeO₂, ZrO₂, La₂O₃, Y₂O₃ SrO, and Fe₂O₃. XRD are illustrated in FIG. 10 (Composition of Example 2), in FIGS. 13A and 13B (Compositions of Example 5A and 5), and in FIG. 17 (Compositions of Examples 1,2,4, and 6). Importantly, the XRD analyses confirm that Examples 1, 2, 3, 4, 6 and 7 remain Tetragonal phase with no perovskite or pyrochlore phases detected. In contrast, the XRD of Example 5A and 5B (FIGS. 13A and 13B) demonstrates the presence of perovskite LaFe₃ with the higher amount of iron included within these compositions.

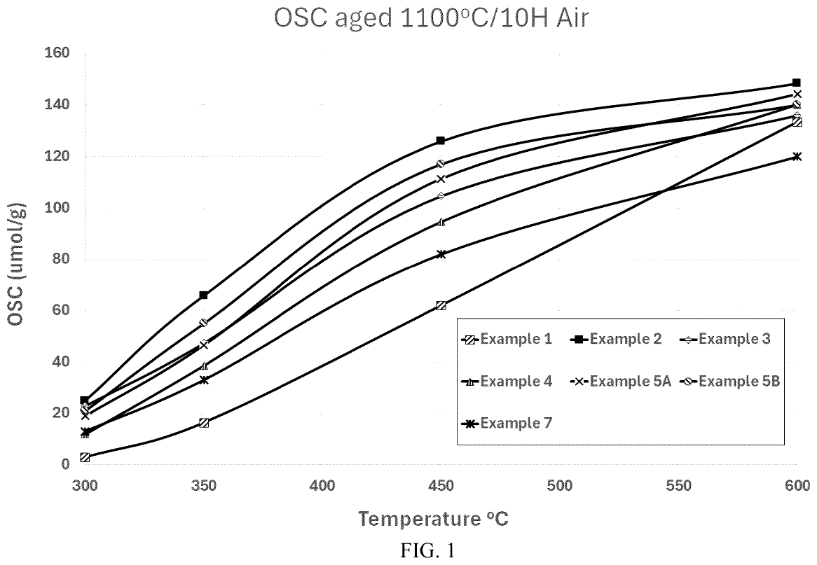

After the compositions of Examples 1, 2, 3, 4, 5A, 5B, and 7 were aged/heated at 1100° C./10H Air, OSC measurements were obtained and the % improvements for Examples 2-7 in comparison to Example 1 were calculated. This data is summarized in Table 2 and graphed in FIG. 1.

TABLE 2

| | | | | | | | % OSC Improvement Aged | | | |
|---|---|---|---|---|---|---|---|---|---|---|
| | | OSC Aged 1100° C./10 H | | | | BET | 1100° C./10 H Air (umol/g) | | | |
| | | Air (umol/g) | | | | 1100° C./ | Relative to Control | | | |
| | XRD Phases | Temperature ° C. | | | | 10 H Air | Temperature ° C. | | | |
| Designation | 1100° C./10 H Air | 300 | 350 | 450 | 600 | (m²/g) | 300 | 350 | 450 | 600 |
| Example 1 | Ce_{0.5}Zr_{0.5}O₂ | 3 | 16 | 62 | 133 | 25.11 | — | — | — | — |
| | Tetragonal | | | | | | | | | |
| Example 2 | Ce_{0.5}Zr_{0.5}O₂ | 25 | 66 | 126 | 148 | 10.03 | 733% | 300% | 103% | 11% |
| | Tetragonal | | | | | | | | | |
| Example 3 | Ce_{0.5}Zr_{0.5}O₂ | 23 | 47 | 105 | 136 | 12.31 | 667% | 188% | 69% | 2% |
| | Tetragonal | | | | | | | | | |
| Example 4 | Ce_{0.5}Zr_{0.5}O₂ | 12 | 39 | 95 | 140 | 15.95 | 300% | 135% | 52% | 5% |
| | Tetragonal | | | | | | | | | |
| Example 5A | Ce_{0.5}Zr_{0.5}O₂ | 19 | 47 | 111 | 144 | 1.78 | 533% | 183% | 80% | 8% |
| | Tetragonal, LaFeO₃ | | | | | | | | | |
| | Orthorhombic | | | | | | | | | |
| Example 5B | Ce_{0.5}Zr_{0.5}O₂ | 21 | 55 | 117 | 140 | 2.96 | 600% | 234% | 89% | 5% |
| | Tetragonal, LaFeO₃ | | | | | | | | | |
| | Orthorhombic | | | | | | | | | |
| Example 7 | Ce_{0.5}Zr_{0.5}O₂ | 13 | 33 | 82 | 120 | 22.33 | 333% | 101% | 32% | −10% |
| | Tetragonal | | | | | | | | | |

Table 2 shows the % OSC improvement of Examples 2 and 4 relative to Example 1, which is compositionally comparable but does not include SrO and Fe₂O₃ (i.e., the amount of ZrO₂ is slightly adjusted for the addition of SrO and Fe₂O₃ but otherwise the compositions are identical within experimentally acceptable error/variation). The compositions containing the disclosed mixture of SrO and Fe₂O₃ (Examples 2 and 4) demonstrate superior OSC (especially at lower temperatures) in comparison to comparative Example 1. Example 2 also demonstrates superior OSC properties in comparison to comparative Example 3 (no SrO) and Example 5A (higher amount of Fe₂O₃ leading to perovskite formation and sintering), as well as Example 5B (slightly higher amount of Fe₂O₃ which also led to perovskite formation and sintering).

FIG. 1 and Table 2 demonstrate that the Example 2 composition, containing a disclosed mixture of SrO and Fe₂O₃, has the highest OSC. It is noted that a 300% increase has a relative increase of three or quadrupling, while a 100% increase is doubling and a 200% increase has a relative change of 2 or tripling.

The composition of Examples 4 and 7 also include a disclosed mixture of SrO and Fe₂O₃, but in smaller amounts. Example 7 also has improved thermal stability as exemplified by high BET surface area post aging at 1100° C./10 h in air. These observed benefits are based on starting materials and the process used to produce the mixed oxides making the resulting OSC formulations tunable based on amount of SrO and Fe₂O₃ contained, and the preparation method used to produce the mixed oxide. The composition of Example 3 contains Fe₂O₃ at same amount as Example 2, but does not contain SrO, demonstrating the importance of SrO to improve OSC (especially at lower temperatures) in comparison to a composition containing Fe₂O₃ alone. The compositions of Example 5A (as well as Example 5B), which include a higher amount of Fe₂O₃, do not show the overall improved results of Examples 2 and 4 due to sintering effect (loss of BET) caused by the formation of LaFeO₃ perovskite as detected via XRD. Thus, these results demonstrate the importance of using the claimed mixture of SrO and Fe₂O₃ to improve OSC, especially at lower temperatures.

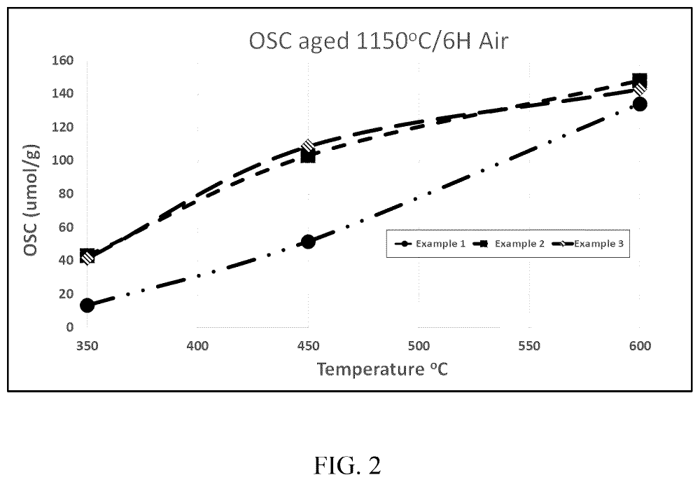

After the compositions of Examples 1-3 were aged/heated at 1150° C./6H Air, OSC measurements were obtained and the % improvements for Examples 2 and 3 in comparison to Example 1 were calculated. This data is summarized in Table 3 and the OSC data was graphed as illustrated in FIG. 2. BET measurements after aging/heating at 1100° C./10H Air and at 1150° C./6H Air also are summarized.

TABLE 3

| | | | | | | | % OSC Improvement | | |
|---|---|---|---|---|---|---|---|---|---|
| | | OSC Aged | | | BET | BET | Aged 1150° C./6 H Air | | |
| | | 1150° C./6 H Air | | | 1100° C./ | 1150° C/ | (umol/g) Relative to | | |
| | | (umol/g) | | | 10 H | 6 H | Control | | |
| | XRD Phases | Temperature ° C. | | | Air | Air | Temperature ° C. | | |
| Designation | 1150° C./6 H Air | 350 | 450 | 600 | (m²/g) | (m²/g) | 350 | 450 | 600 |
| Example 1 | Ce_{0.5}Zr_{0.5}O₂ | 13 | 52 | 134 | 25.11 | 15.01 | — | — | — |
| Example 2 | Ce_{0.5}Zr_{0.5}O₂ | 43 | 103 | 148 | 10.03 | 2.06 | 220% | 100% | 10% |
| Example 3 | Ce_{0.5}Zr_{0.5}O₂ | 41 | 109 | 143 | 12.31 | 5.33 | 208% | 110% | 6% |

The results in Table 3 demonstrate that post 1150° C./6H Air aging the composition of Example 2 has a BET surface area significantly below 10 m²/g, but with improved OSC.

The results in Table 3 and illustrated in FIG. 2 demonstrate that even post 1150° C./6H Air aging, the composition of Example 2 (with a disclosed mixture of SrO and Fe₂O₃) exhibits superior OSC, especially at low temperatures, as compared to the composition of Example 1 (which does not contain any SrO or Fe₂O₃). OSC of Example 2 remains 2-3 times higher in comparison to OSC of Example 1.

Table 4 summarizes characterizations of Examples 1, 3, 4, and 6. In particular, Table 4 demonstrates the effects of changing the precipitating agent used during preparation of the compositions. Table 4 demonstrates that changing the precipitating agent used during preparation of the compositions can impact pore size. Examples 1, 3, and 4 used NH₄OH as the precipitating agent. In contrast, Example 6 has the same composition as Example 4, but used quaternary ammonium hydroxide (QAH) tetra methyl ammonium hydroxide (TMAOH) as the precipitating agent.

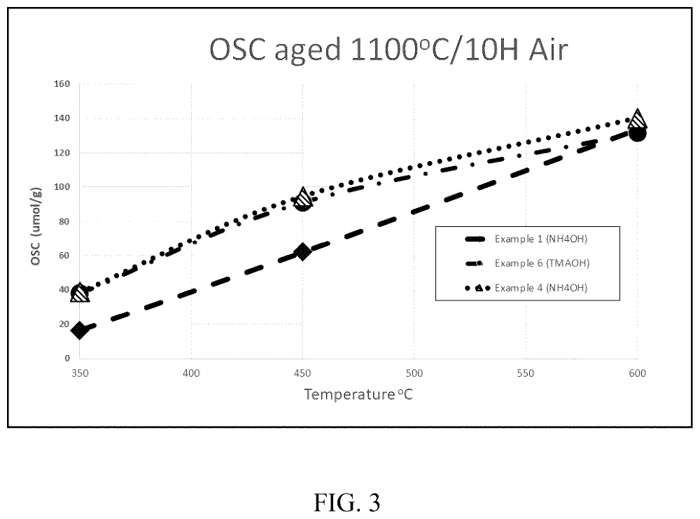

After the compositions of Examples 1, 3, 4, and 6 were aged/heated at 1100° C./10H Air, OSC measurements were obtained. This data is summarized in Table 4 and the data was graphed as illustrated in FIG. 3. The BET surface area, BJH pore volume, and BJH pore radius/size (FIG. 4) were measured for the as-prepared compositions (i.e., fresh). Particle size also was measured. Table 4 below summarizes all of these results.

TABLE 4

| | OSC Aged 1100° C./ | | | D90 | Fresh | | |
|---|---|---|---|---|---|---|---|
| | 10 h Air (umol/g) | | | Particle | BET | Fresh BJH | Fresh BJH |
| Designation | 350 | 450 | 600 | Size (μ) | (m²/g) | PV (cm³/g) | Radius (Å) |
| Example 1 | 16 | 62 | 133 | 7.40 | 72.70 | 0.40 | 95.80 |
| (NH₄OH) | | | | | | | |
| Example 3 | 47 | 105 | 136 | 13.96 | 48.52 | 0.35 | 118.37 |
| (NH₄OH) | | | | | | | |
| Example 4 | 39 | 95 | 140 | 8.68 | 57.16 | 0.32 | 120.54 |
| (NH₄OH) | | | | | | | |
| Example 6 | 38 | 91 | 132 | 12.28 | 62.26 | 0.36 | 75.53 |
| (NH₄OH) | | | | | | | |

The results in Table 4 and illustrated in FIG. 3 demonstrate that post 1100° C./10H Air aging, the compositions of Examples 4 and 6 (with disclosed mixtures of SrO and Fe₂O₃) exhibits superior OSC (approximately double, especially at low temperatures) as compared to the composition of Example 1 (which does not contain any SrO or Fe₂O₃).

The data in Table 4 and as illustrated in FIG. 4 also demonstrates that changing the precipitating agent used during preparation of the compositions can impact pore size. As described above, the material of Example 6 has the same composition as Example 4, with the only difference being the precipitating agent used (Example 6 uses TMAOH). This demonstrates the impact of TMAOH on pore size, indicating use of primary, secondary, tertiary, and quaternary ammonium hydroxides can be used to augment pore size without negatively impacting other physical properties.

Compositions of Examples 2, 5A, and 5B were further characterized by TEM and EDS, as well as XRD as described above and further described below.

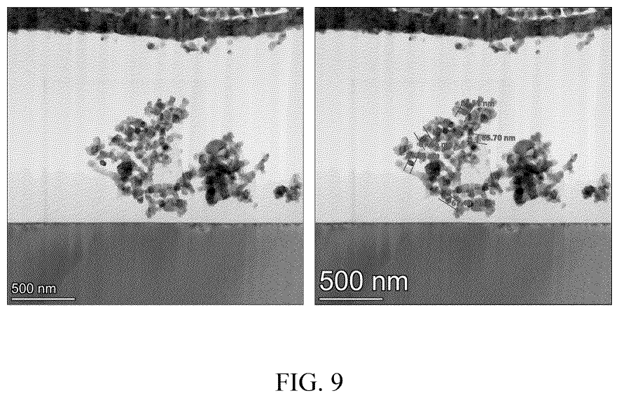

FIG. 9 depicts TEM images of the composition of Example 2 after aging/heating at 1100° C./10 h Air. FIG. 9 demonstrates that crystallites remain small even after 1100° C./10 h Air aging, while BET surface area and OSC remain high as described above. These results demonstrate the significant impact of the presently disclosed mixture of SrO and Fe₂O₃. As described above, the XRD of Example 2 (illustrated in FIG. 10) confirms no presence of perovskite or any other highly crystalline phase such as pyrochlore. The XRD of Example 2 confirms the composition remains tetragonal.

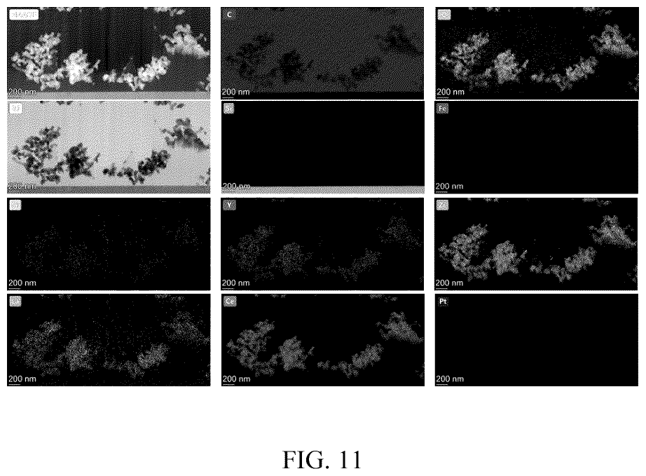

FIG. 11 depicts EDS images of the composition of Example 2 after aging/heating at 1100° C./10 h Air. The EDS images also do not show the presence of any perovskite formation (with reference to the Sr, Fe, and La maps—in these images only highly dispersed La₂O₃ was detected).

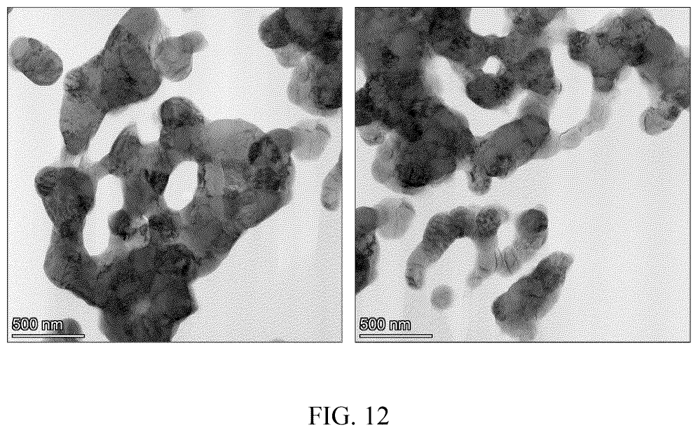

FIG. 12 depicts TEM images of the composition of Example 5A after aging/heating at 1100° C./10 h Air. Example 5A is outside the scope of the claims because it includes a higher amount of Fe₂O₃, and Example 5B also includes a higher amount of Fe₂O₃. As FIG. 12 illustrates, in comparison to FIG. 9, the disclosed amount of Fe₂O₃ is significant. FIG. 12 (TEM images of Example 5A) in comparison to FIG. 9 (TEM images of Example 2) shows that under the same aging conditions the composition of Example 5A is highly sintered. This result is due to the presence of a perovskite phase, which acts as a sintering aid.

As described above, the XRD of Examples 5A and 5B (FIGS. 13A and 13B) also confirm the presence of perovskite LaFeO₃ with higher amounts of iron included within these compositions. The XRD peak list for Example 5B and FIG. 13B is as follows:

Peak List:

| Pos. | Height | FWHM | d-spacing | Rel. Int. |
|---|---|---|---|---|
| [°2Th.] | [cts] | [°2Th.] | [Å] | [%] |
| 29.4724 | 6469.53 | 0.2992 | 3.02827 | 100 |
| 32.2475 | 96 | 0.0743 | 2.77373 | 1.48 |
| 34.1517 | 1493.56 | 0.3063 | 2.6233 | 23.09 |
| 40.7534 | 20.58 | 4 | 2.21229 | 0.32 |
| 46.1573 | 75.07 | 0.0698 | 1.96508 | 1.16 |
| 49.0501 | 2191.06 | 0.4474 | 1.85574 | 33.87 |
| 49.4234 | 510.52 | 4 | 1.84259 | 7.89 |
| 57.3927 | 103.19 | 0.5258 | 1.60423 | 1.6 |
| 58.2346 | 1379.6 | 0.5269 | 1.58302 | 21.32 |
| 61.0901 | 182.52 | 0.9366 | 1.51569 | 2.82 |
| 71.8472 | 131.92 | 1.3958 | 1.31292 | 2.04 |
| 79.4632 | 311.4 | 0.9362 | 1.20511 | 4.81 |
| 81.9667 | 173.09 | 1.4485 | 1.17452 | 2.68 |
| 91.8911 | 233.1 | 1.006 | 1.07183 | 3.6 |
| 99.2941 | 167.92 | 1.5578 | 1.0108 | 2.6 |

Pattern List:

| Ref. Code | Score | Compound Name | Chemical Formula |
|---|---|---|---|
| 00-038-1436 | 69 | Cerium Zirconium Oxide | Zr0.5 Ce0.5 O2 |
| 01-075-0541 | 20 | Lanthanum iron (III) oxide | La Fe O3 |

The presence of perovskite LaFeO₃ is significant because it acts as a sintering aid causing the mixed oxide composition of Example 5A, as well as Example 5B, to sinter. Although the OSC of Examples 5A and 5B remain higher than Example 1, the loss of BET surface area begins to negatively impact OSC resulting in a non-linear OSC response in comparison to the mixed oxide compositions containing a preferred mixture of SrO and Fe₂O₃.

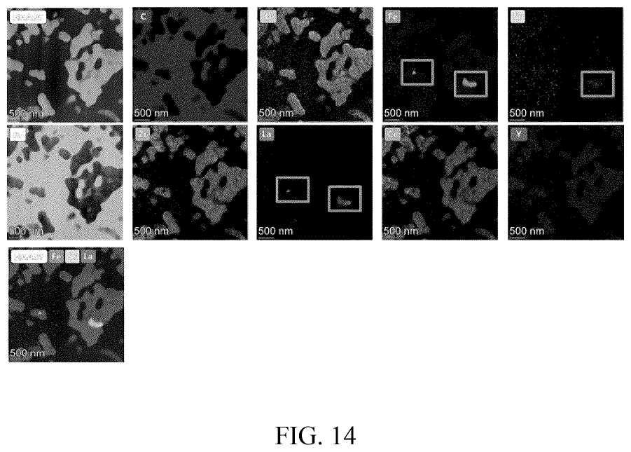

FIG. 14 depicts EDS images of the composition of Example 5A after aging/heating at 1100° C./10 h Air. The EDS images confirm La, Fe and Sr have formed aggregated areas (with reference to the Sr, Fe, and La maps). This is indicative of the highly crystalline LaFeO₃ type perovskite. As described herein, formation of a perovskite phase is detrimental as it acts as a sintering aid. This should be compared to FIG. 11 (EDS images for the composition of Example 2), which do not show the presence of any perovskite formation.

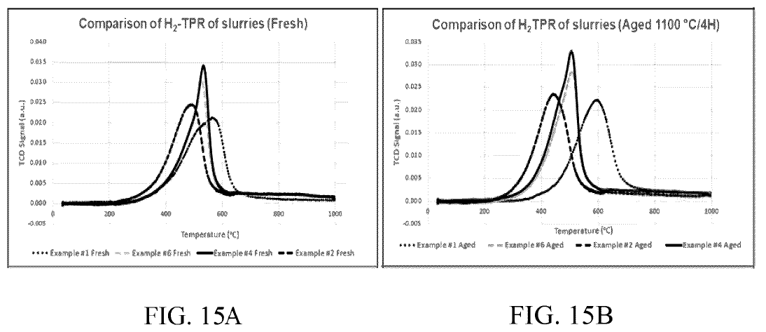

H₂TPR data was obtained for slurries of Examples 1, 2, 4, and 6 as-prepared (i.e., fresh) and after aging/heating at 1100° C./4H in Air. FIGS. 15A and 15B graphically present this data and shows that all peaks are single mode and symmetrical. FIG. 15A demonstrates that the as-prepared (i.e., fresh) compositions follow the trend with Example 2 having a lower light-off temperature than Examples 4 and 6 (which are about the same), and all three (Examples 2, 4, and 6) having a lower peak temperature than Example 1. After aging/heating at 1100° C./4H in Air, the H₂TPR data maintains the trend with Example 2 having a lower light-off temperature than Examples 4 and 6 (which are about the same), and all three (Examples 2, 4, and 6) having a lower temperate than Example 1.

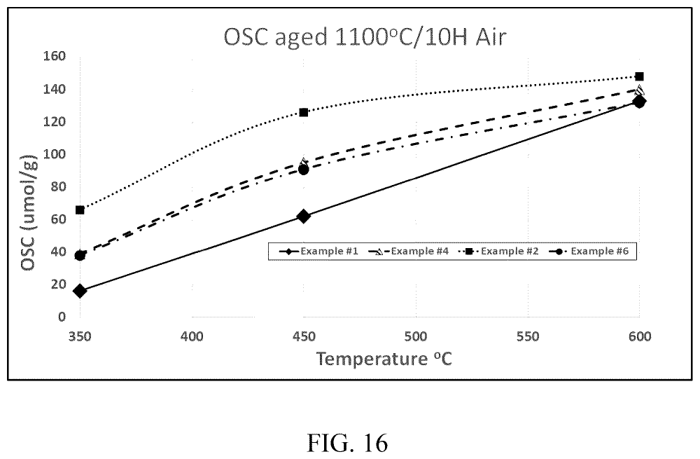

After the compositions of Examples 1, 2, 4, and 6 were aged/heated at 1100° C./10H Air, OSC measurements were obtained. This data is summarized in Table 5 and the data was graphed as illustrated in FIG. 16. The BET surface area for heated/aged compositions also was measured and is summarized in Table 5. This OSC data is presented for comparison to the H₂TPR data.

TABLE 5
OSC Data for Comparison to H2TPR Data

| | OSC Aged 1100° C./ | | | BET | OSC, % Improvement | | |
|---|---|---|---|---|---|---|---|
| | 10 h Air (umol/g) | | | 1100° C./10 h | Over Control | | |
| Sample ID | 350° C. | 450° C. | 600° C. | Air | 350° C. | 450° C. | 600° C. |
| Example 1 | 16 | 62 | 133 | 25.11 | — | — | — |
| Example 2 | 66 | 126 | 148 | 10.03 | 313% | 103% | 11% |
| Example 4 | 39 | 95 | 140 | 15.95 | 144% | 53% | 5% |
| Example 6 | 38 | 91 | 132 | 11.78 | 138% | 47% | −1% |

The data as summarized in Table 5 and illustrated in FIG. 16 demonstrate the same trend for improvement as the H₂TPR results: Example 2 has most improved OSC (especially at lower temperature); Examples 6 and 4 have improved and comparable OSC (especially at lower temperatures); and comparative Example 1 has the lowest OSC (especially at lower temperature)—with OSC for all compositions leveling off as temperatures approach 600° C.

Importantly, and as can be seen from the OSC data in comparison to the H₂TPR results, the trend for what compositions have the higher OSC at a given temperature is reversed relative to what compositions have higher H₂TPR (i.e., Example 2 has the highest OSC and lowest H₂TPR and Comparative Example 1 has the lowest OSC and highest H₂TPR). This trend demonstrates that a lower H₂TPR reduction temperature is indicative of a more active OSC material. A lower H₂TPR peak temperature demonstrates a more active/lower light-off temperature and is indicative of improved low temperature OSC.

Table 6 summarizes H₂TPR data for the compositions of Examples 1, 2, 4, and 6 as-prepared (i.e., fresh) and after aging/heating at 1100° C./4H Air. Table 6 also summarizes BET and XRD after aging/heating at 1000° C./10H using CO/O₂ rich/lean atmosphere cycling for Examples 1, 2, 4, and 6.

TABLE 6
H₂TPR Data Table and Aged BET and XRD Results

| | | Temp. | H₂ | CO/O₂ | CO/O₂ |
|---|---|---|---|---|---|
| | | at Max | Consumption | 1000° C. | 1000° C. |
| Sample ID# | | (° C.) | (umol/g) | 10 H Aged BET | 10 H Aged XRD |
| Example #1 | Fresh | 568 | 1079 | 31.87 | Tetragonal CZO |
| | 1100° C./4 H | 593 | 1001 | | |
| Example #2 | Fresh | 491 | 937 | 16.38 | Tetragonal CZO |
| | 1100° C./4 H | 442 | 875 | | |
| Example #4 | Fresh | 534 | 972 | 24.21 | Tetragonal CZO |
| | 1100° C./4 H | 507 | 954 | | |
| Example #6 | Fresh | 528 | 944 | 22.75 | Tetragonal CZO |
| | 1100° C./4 H | 507 | 951 | | |

The XRD results as summarized in Table 6 and illustrated in FIG. 17 (Comparison of Examples 1, 2, 4, and 6) confirm that Examples 1, 2, 4, and 6 remain Tetragonal phase with no perovskite or pyrochlore phases detected, even after aging 1000° C./10H CO/O₂, rich/lean aging, which is a more severe aging cycle.

### Example 8: Preparation of Ceria Zirconia Composition Including SrO and Fe₂O₃

A 6.0 Kg batch of Ceria Zirconia with targeted composition, 40/49.3/5/5/0.2/0.5, CeO₂/ZrO₂/La₂O₃/Y₂O₃/SrO/Fe₂O₃ is made by first dissolving 7.395 Kg ZBC (Zirconium basic carbonate), 3.636 Kg Ce(OH)₄ (Cerium IV hydroxide) and 0.475 Kg Y₂(CO₃)₃ (Yttrium carbonate) in a mixture of 28 L DI H₂O (deionized water) and 15 L 8M HNO₃ (Nitric acid). The mixed rare earth zirconium nitrate solution is then precipitated with a mixture of 63 L DI H₂O (deionized water), 31.5 L NH₄OH (Ammonium hydroxide, 25% NH₃ water) and 3.0 Kg C₁₂H₂₄O₂(Lauric acid). The final pH of step 1 is controlled between 9.5 and 10.0.

As a second step, a mixture of 0.545 Kg La₂(CO₃)₃ (Lanthanum carbonate), 0.025 Kg Sr(NO₃)₂ (Strontium nitrate) and 0.152 Kg Fe(NO₃)_{3.9}H₂O (Iron(III) Nitrate Nonahydrate) dissolved in 1.0 L 8M HNO₃ (Nitric acid) and 2.6 L DI H₂O (deionized water) is added to the precipitate from the first step with final pH controlled between 9.5 and 10.0. Continuous mixing is employed throughout. The final precipitate is then filtered, washed and calcined at 750° C. to 1000° C., with 950±50° C. preferred. The material is then milled to final particle size D90≤20 μm.

### Example 9: Preparation of Ceria Zirconia Composition Including SrO and Fe₂O₃

A 6.0 Kg batch of Ceria Zirconia with targeted composition, 40/49.94/5/5/0.02/0.05 CeO₂/ZrO₂/La₂O₃/Y₂O₃/SrO/Fe₂O₃ was made by first dissolving 7.490 Kg ZBC (Zirconium basic carbonate), 3.636 Kg (NH₄)₂[Ce(NO₃)₆](Ammonium Cerium Nitrate) and 28 L DI H₂O (deionized water) and 10 L 8M HNO₃ (Nitric acid) and heating for 1 h @55-65° C.

As a second step, a mixture of 0.545 Kg La₂(CO₃)₃ (Lanthanum carbonate), 0.475 Kg Y₂(CO₃)₃ (Yttrium carbonate), 0.00018 Kg Sr(NO₃)₂ (Strontium nitrate) and 0.0152 Kg Fe(NO₃)_{3.9}H₂O (Iron(III) Nitrate Nonahydrate) dissolved in 5.0 L 8M HNO₃ (Nitric acid) and 2.6 L DI H₂O (deionized water) was added to the first step. The mixed rare earth zirconium nitrate solution was then precipitated with a mixture of 63 L DI H₂O (deionized water), 31.5 L NH₄OH (Ammonium hydroxide, 25% NH₃ water) and 3.0 Kg C₁₂H₂₄O₂(Lauric acid). The final pH was controlled between 9.5 and 10.0. Continuous mixing was employed throughout. The final precipitate was then filtered, washed and calcined to 750° C. to 1000° C., with 950±50° C. preferred. The material was then milled to final particle size D90≤20 μm.

### Washcoat Suspension Examples

### Comparative Example 10: Preparation of Washcoat Using Ceria Zirconia Composition of Example 1

A 6.0 Kg oxide basis washcoat slurry was prepared by adding 3.75 Kg Example 1, 1.78 Kg La₂O₃/Al₂O₃, 0.55 Kg BaSO₄ and 0.09 Kg Pseudoboehmite binder to 6.24 Kg DI water, 0.3 Kg glacial acetic acid and 0.15 Kg Sucrose. The final slurry solid content for coating was targeted at 43%, 1000° C. solids basis.

The washcoat was prepared and dried/calcined (550° C. for 2 hours). Chemical data for the composition can be found below in Table 7, and physical data for the composition can be found below in Table 8.

Then the dried slurry powder was aged 1100° C. for 10 hours in Air and OSC was measured per the method described herein. Table 9 presents OSC data for the aged mixed-oxide washcoat under three circumstances: as the mixed-oxide washcoat only (prior to addition of a PGM, i.e., ex-PGM), as the washcoat plus 1.5% wt. Pd as metal calculated on a mixed oxide basis (301.3 g Pd—N added as a solution supplied at 18% Pd metal content), and as the washcoat plus 0.5% Rh as metal calculated on a mixed oxide basis (181.9 g Rh—N added as a solution supplied at 10% Rh metal content).

### Example 11: Preparation of Washcoat Using Ceria Zirconia Composition of Example 2

A 6.0 Kg oxide basis washcoat slurry was prepared by adding 3.75 Kg Example 2, 1.78 Kg La₂O₃/Al₂O₃, 0.55 Kg BaSO₄ and 0.09 Kg Pseudoboehmite binder to 6.24 Kg DI water, 0.3 Kg glacial acetic acid and 0.15 Kg Sucrose. The final slurry solid content for coating was targeted at 43%, 1000° C. solids basis.

The washcoat was prepared and dried/calcined (550° C. for 2 hours). Chemical data for the composition can be found below in Table 7, and physical data for the composition can be found below in Table 8.

Then the dried slurry powder was aged 1100° C. for 10 hours in Air and OSC was measured per the method described herein. Table 9 presents OSC data for the aged mixed-oxide washcoat described herein under three circumstances: as the mixed-oxide washcoat only (prior to addition of a PGM, i.e., ex-PGM), as the washcoat plus 1.5% wt. Pd as metal calculated on a mixed oxide basis (301.3 g Pd—N added as a solution supplied at 18% Pd metal content), and as the washcoat plus 0.5% Rh as metal calculated on a mixed oxide basis (181.9 g Rh—N added as a solution supplied at 10% Rh metal content).

### Comparative Example 12: Preparation of Washcoat Using Ceria Zirconia Composition of Example 3

A 6.0 Kg oxide basis washcoat slurry was prepared by adding 3.75 Kg Example 3, 1.78 Kg La₂O₃/Al₂O₃, 0.55 Kg BaSO₄ and 0.09 Kg Pseudoboehmite binder to 6.24 Kg DI water, 0.3 Kg glacial acetic acid and 0.15 Kg Sucrose. The final slurry solid content for coating was targeted at 43%, 1000° C. solids basis.

The washcoat was prepared and dried/calcined (550° C. for 2 hours). Chemical data for the composition can be found below in Table 7, and physical data for the composition can be found below in Table 8.

Then the dried slurry powder was aged 1100° C. for 10 hours in Air and OSC was measured per the method described herein. Table 9 presents OSC data for the aged mixed-oxide washcoat described herein under three circumstances: as the mixed-oxide washcoat only (prior to addition of a PGM, i.e., ex-PGM), as the washcoat plus 1.5% wt. Pd as metal calculated on a mixed oxide basis (301.3 g Pd—N added as a solution supplied at 18% Pd metal content), and as the washcoat plus 0.5% Rh as metal calculated on a mixed oxide basis (181.9 g Rh—N added as a solution supplied at 10% Rh metal content).

### Comparative Example 13: Preparation of Washcoat Using Ceria Zirconia Composition of Example 1

A 6.0 Kg oxide basis washcoat slurry was prepared by adding 3.75 Kg Example 1, 1.78 Kg La₂O₃/Al₂O₃, 0.55 Kg BaSO₄ and 0.09 Kg Pseudoboehmite binder to 6.24 Kg DI water, 0.3 Kg glacial acetic acid and 0.15 Kg Sucrose. The final slurry solid content for coating was targeted at 43%, 1000° C. solids basis.

The washcoat was prepared and dried/calcined (550° C. for 2 hours). Chemical data for the composition can be found below in Table 7, and physical data for the composition can be found below in Table 8.

Then the dried slurry powder was aged 1100° C. for 10 hours in Air and OSC was measured per the method described herein. Table 10 presents OSC data for the aged mixed-oxide washcoat plus 0.23% Rh as metal on a mixed oxide basis (83.2 g Rh—N added as a solution supplied at 10% Rh metal content).

### Example 14: Preparation of Washcoat Using Ceria Zirconia Composition of Example 2

A 6.0 Kg oxide basis washcoat slurry was prepared by adding 3.75 Kg Example 2, 1.78 Kg La₂O₃/Al₂O₃, 0.55 Kg BaSO₄ and 0.09 Kg Pseudoboehmite binder to 6.24 Kg DI water, 0.3 Kg glacial acetic acid and 0.15 Kg Sucrose. The final slurry solid content for coating was targeted at 43%, 1000° C. solids basis.

The washcoat was prepared and dried/calcined (550° C. for 2 hours). Chemical data for the composition can be found below in Table 7, and physical data for the composition can be found below in Table 8.

Then the dried slurry powder was aged 1100° C. for 10 hours in Air and OSC was measured per the method described herein. Table 10 presents OSC data for the aged mixed-oxide washcoat plus 0.23% Rh as metal on a mixed oxide basis (83.2 g Rh—N added at 10% Rh content).

### Comparative Example 15: Preparation of Washcoat Using Ceria Zirconia Composition of Example 3

A 6.0 Kg oxide basis washcoat slurry was prepared by adding 3.75 Kg Example 3, 1.78 Kg La₂O₃/Al₂O₃, 0.55 Kg BaSO₄ and 0.09 Kg Pseudoboehmite binder to 6.24 Kg DI water, 0.3 Kg glacial acetic acid and 0.15 Kg Sucrose. The final slurry solid content for coating was targeted at 43%, 1000° C. solids basis.

The washcoat was prepared and dried/calcined (550° C. for 2 hours). Chemical data for the composition can be found below in Table 7, and physical data for the composition can be found below in Table 8.

Then the dried slurry powder was aged 1100° C. for 10 hours in Air and OSC was measured per the method described herein. Table 10 presents OSC data for the aged mixed-oxide washcoat plus 0.23% Rh as metal on a mixed oxide basis (83.2 g Rh—N added as a solution supplied at 10% Rh metal content).

### Summary of Characteristics of Washcoats

The compositional contents of the washcoats of Examples 10-15 are summarized in Table 7 below.

TABLE 7
Washcoat Compositions

| | Composition, % Washcoat Solids Basis and Mixed Oxide (MO) Basis | | | | | | | | |
|---|---|---|---|---|---|---|---|---|---|
| Catalytic Washcoat | | | | | % Pd | % Rh | | % Pd/ | % Rh/ |
| Designation, PGM on | Mixed- | | | Pseudo- | (wash | (wash | | Mixed- | Mixed- |
| Mixed Oxide (MO) Basis | Oxide | La/Al₂O₃ | BaSO₄ | boehmite | coat) | coat) | Total | Oxide | Oxide |
| Example 10 (Ex-PGM) | 60.85% | 29.02% | 9.13% | 1.00% | — | — | 100.00% | — | — |
| 40/50/5/5, | | | | | | | | | |
| CeO₂/ZrO₂/La₂O₃/Y₂O₃ | | | | | | | | | |
| Example 10 + 1.5% | 60.30% | 28.75% | 9.05% | 1.00% | 0.90% | — | 100.00% | 1.50% | — |
| Pd/MO Basis, 40/50/5/5, | | | | | | | | | |
| CeO₂/ZrO₂/La₂O₃/Y₂O₃ | | | | | | | | | |
| Example 10 + 0.5% | 60.67% | 28.93% | 9.10% | 1.00% | — | 0.30% | 100.00% | — | 0.50% |
| Rh/MO Basis, 40/50/5/5, | | | | | | | | | |
| CeO₂/ZrO₂/La₂O₃/Y₂O₃ | | | | | | | | | |
| Example 11 (Ex-PGM), | 60.85% | 29.02% | 9.13% | 1.00% | — | — | 100.00% | — | — |
| 40/49.56/5/5/0.09/0.35, | | | | | | | | | |
| CeO₂/ZrO₂/La₂O₃/Y₂O₃/ | | | | | | | | | |
| SrO/Fe₂O₃ | | | | | | | | | |
| Example 11 + 1.5% | 60.30% | 28.75% | 9.05% | 1.00% | 0.90% | — | 100.00% | 1.50% | — |
| Pd/MO Basis, | | | | | | | | | |
| 40/49.56/5/5/0.09/0.35, | | | | | | | | | |
| CeO₂/ZrO₂/La₂O₃/Y₂O₃/ | | | | | | | | | |
| SrO/Fe₂O₃ | | | | | | | | | |
| Example 11 + 0.5% | 60.67% | 28.93% | 9.10% | 1.00% | — | 0.30% | 100.00% | — | 0.50% |
| Rh/MO Basis, | | | | | | | | | |
| 40/49.56/5/5/0.09/0.35, | | | | | | | | | |
| CeO₂/ZrO₂/La₂O₃/Y₂O₃/ | | | | | | | | | |
| SrO/Fe₂O₃ | | | | | | | | | |
| Example 12 (Ex-PGM), | 60.85% | 29.02% | 9.13% | 1.00% | — | — | 100.00% | — | — |
| 40/49.67/5/5/0.33, | | | | | | | | | |
| CeO₂/ZrO₂/La₂O₃/Y₂O₃/ | | | | | | | | | |
| Fe₂O₃ | | | | | | | | | |
| Example 12 + 1.5% | 60.30% | 28.75% | 9.05% | 1.00% | 0.90% | — | 100.00% | 1.50% | — |
| Pd/MO Basis, | | | | | | | | | |
| 40/49.67/5/5/0.33, | | | | | | | | | |
| CeO₂/ZrO₂/La₂O₃/Y₂O₃/ | | | | | | | | | |
| Fe₂O₃ | | | | | | | | | |
| Example 12 + 0.5% | 60.67% | 28.93% | 9.10% | 1.00% | — | 0.30% | 100.00% | — | 0.50% |
| Rh/MO Basis, | | | | | | | | | |
| 40/49.67/5/5/0.33, | | | | | | | | | |
| CeO₂/ZrO₂/La₂O₃/Y₂O₃/ | | | | | | | | | |
| Fe₂O₃ | | | | | | | | | |
| Example 13 + 0.23% | 60.77% | 28.97% | 9.12% | 1.00% | — | 0.14% | 100.00% | — | 0.23% |
| Rh/MO Basis, 40/50/5/5, | | | | | | | | | |
| CeO₂/ZrO₂/La₂O₃/Y₂O₃ | | | | | | | | | |
| Example 14 + 0.23% | 60.77% | 28.97% | 9.12% | 1.00% | — | 0.14% | 100.00% | — | 0.23% |
| Rh/MO Basis, | | | | | | | | | |
| 40/49.56/5/5/0.09/0.35 | | | | | | | | | |
| CeO₂/ZrO₂/La₂O₃/Y₂O₃/ | | | | | | | | | |
| SrO/Fe₂O₃ | | | | | | | | | |
| Example 15 + 0.23% | 60.77% | 28.97% | 9.12% | 1.00% | — | 0.14% | 100.00% | — | 0.23% |
| Rh/MO 40/49.67/5/5/0.33, | | | | | | | | | |
| CeO₂/ZrO₂/La₂O₃/Y₂O₃/ | | | | | | | | | |
| Fe₂O₃ | | | | | | | | | |

Table 8 summarizes the solids content, pH, and viscosity of the washcoat slurries of Examples 10-15. Table 8 also provides the particle size distribution of these washcoats after the washcoats were dried/calcined (550° C. for 2 hours). Table 8 further summarizes the SA BET after the dried slurry powders of the washcoats of Examples 10-15 were aged at 1100° C. for 10 hours in air.

TABLE 8
Washcoat/Slurry Physical Properties

| | | | | | | | SA BET |
|---|---|---|---|---|---|---|---|
| | | | Viscosity | Particle Size | | | Method |
| Catalytic Washcoat | % Solid | | (cp @ | Distribution | | | 1100° C./10 H |
| Designation | Content | pH | 300/s) | D10 | D50 | D90 | Air |
| Example 10 (Ex-PGM) | 42.8% | 4.67 | 60.4 | 2.59 | 5.02 | 9.24 | 30.07 |
| 40/50/5/5, | | | | | | | |
| CeO₂/ZrO₂/La₂O₃/Y₂O₃ | | | | | | | |
| Example 10 + 1.5% Pd/MO | 43.3% | 4.31 | 275.5 | 2.40 | 4.88 | 9.29 | 30.31 |
| Basis, 40/50/5/5, | | | | | | | |
| CeO₂/ZrO₂/La₂O₃/Y₂O₃ | | | | | | | |
| Example 10 + 0.5% Rh/MO | 42.4% | 4.45 | 108.9 | 2.58 | 4.95 | 8.97 | 29.82 |
| Basis, 40/50/5/5, | | | | | | | |
| CeO₂/ZrO₂/La₂O₃/Y₂O₃ | | | | | | | |
| Example 11 (Ex-PGM), | 43.7% | 4.85 | 126.0 | 2.65 | 5.44 | 10.61 | 30.95 |
| 40/49.56/5/5/0.09/0.35, | | | | | | | |
| CeO₂/ZrO₂/La₂O₃/Y₂O₃/ | | | | | | | |
| SrO/Fe₂O₃ | | | | | | | |
| Example 11 + 1.5% Pd/MO | 42.7% | 4.30 | 464.7 | 2.78 | 5.34 | 9.89 | 28.65 |
| Basis, 40/49.56/5/5/0.09/0.35, | | | | | | | |
| CeO₂/ZrO₂/La₂O₃/Y₂O₃/ | | | | | | | |
| SrO/Fe₂O₃ | | | | | | | |
| Example 11 + 0.5% Rh/MO | 43.1% | 4.40 | 259.6 | 2.68 | 5.41 | 10.50 | 29.54 |
| Basis, 40/49.56/5/5/0.09/0.35, | | | | | | | |
| CeO₂/ZrO₂/La₂O₃/Y₂O₃/ | | | | | | | |
| SrO/Fe₂O₃ | | | | | | | |
| Example 12 (Ex-PGM), | 43.3% | 4.88 | 91.0 | 2.72 | 5.82 | 11.89 | 29.49 |
| 40/49.67/5/5/0.33, | | | | | | | |
| CeO₂/ZrO₂/La₂O₃/Y₂O₃/ | | | | | | | |
| Fe₂O₃ | | | | | | | |
| Example 12 + 1.5% Pd/MO | 43.3% | 4.25 | 110.2 | 2.58 | 5.54 | 11.76 | 29.05 |
| Basis, 40/49.67/5/5/0.33, | | | | | | | |
| CeO2/ZrO2/La203/Y203/ | | | | | | | |
| Fe₂O₃ | | | | | | | |
| Example 12 + 0.5% Rh/MO | 43.6% | 4.40 | 151.4 | 2.57 | 5.70 | 11.78 | 29.61 |
| Basis, 40/49.67/5/5/0.33, | | | | | | | |
| CeO₂/ZrO₂/La₂O₃/Y₂O₃/ | | | | | | | |
| Fe₂O₃ | | | | | | | |
| Example 13 + 0.23% Rh/MO | 42.1% | 4.94 | 182.6 | 2.41 | 5.12 | 10.25 | 28.25 |
| Basis, 40/50/5/5, | | | | | | | |
| CeO₂/ZrO₂/La₂O₃/Y₂O₃ | | | | | | | |
| Example 14 + 0.23% Rh/MO | 42.3% | 4.94 | 250.3 | 2.49 | 5.20 | 10.43 | 29.92 |
| Basis, 40/49.56/5/5/0.09/0.35 | | | | | | | |
| CeO₂/ZrO₂/La₂O₃/Y₂O₃/ | | | | | | | |
| SrO/Fe₂O₃ | | | | | | | |
| Example 15 + 0.23% Rh/MO | 42.1% | 5.00 | 310.7 | 2.68 | 5.73 | 11.73 | 28.43 |
| Basis, 40/49.67/5/5/0.33, | | | | | | | |
| CeO₂/ZrO₂/La₂O₃/Y₂O₃/ | | | | | | | |
| Fe₂O₃ | | | | | | | |

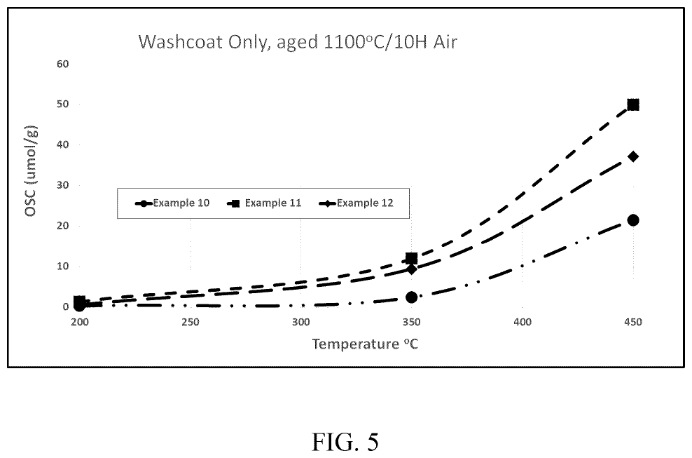

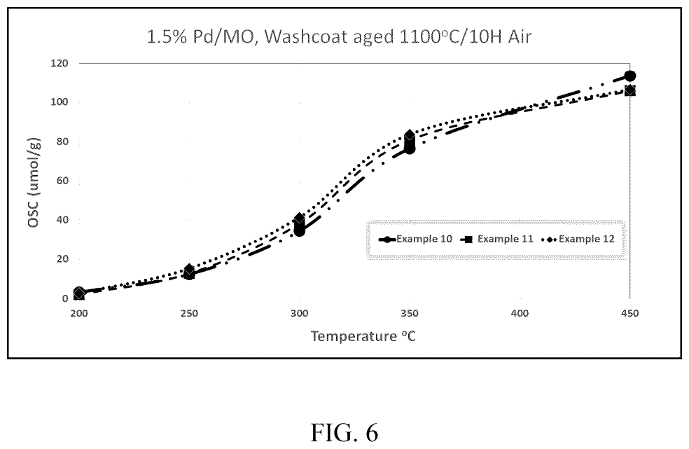

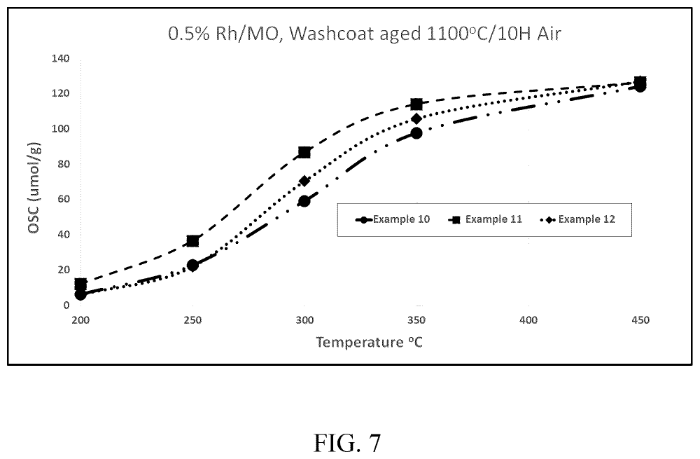

As described, the example washcoats were dried/calcined (550° C. for 2 hours) and then the dried slurry powders of the washcoats of Examples 10-12 were aged at 1100° C. for 10 hours in air. After the washcoats of Examples 10-12 were aged/heated at 1100° C./10H Air, OSC measurements were obtained and the % improvements for Examples 11 and 12 in comparison to Example 10 were calculated. This data is summarized in Table 9, and the data was graphed as illustrated in FIG. 5 (without PGMs/ex-PGM), FIG. 6 (1.5 wt. % Pd/MO basis), and FIG. 7 (0.5 wt. % Rh/MO basis).

TABLE 9
Washcoat OSC Data Examples 10-12 (Aged 1100° C./10 h Air (umol/g))

| | OSC MO Only | | | 1.5% Pd Mixed | | | | | 0.5% Pd Mixed | | | | |
|---|---|---|---|---|---|---|---|---|---|---|---|---|---|
| | (Ex-PGM) Slurry, | | | Oxide Basis Slurry | | | | | Oxide Basis Slurry | | | | |
| | Aged 1100° C./ | | | Aged 1100° C./ | | | | | Aged 1100° C./ | | | | |
| | 10 h Air (umol/g) | | | 10 h Air (umol/g) | | | | | 10 h Air (umol/g) | | | | |
| Catalytic | Temperature | | | Temperature | | | | | Temperature | | | | |
| Washcoat | ° C. | | | ° C. | | | | | ° C. | | | | |
| Designation | 200 | 350 | 450 | 200 | 250 | 300 | 350 | 450 | 200 | 250 | 300 | 350 | 450 |
| Example 10 | 0.37 | 2.49 | 21.46 | 3.32 | 12.47 | 34.62 | 76.67 | 113.66 | 3.24 | 22.74 | 59.23 | 97.84 | 124.26 |
| Example 11 | 1.41 | 12.01 | 49.97 | 2.25 | 12.91 | 38.28 | 80.87 | 105.97 | 12.07 | 36.66 | 86.90 | 114.10 | 126.40 |
| Example 12 | 0.58 | 9.43 | 37.15 | 2.81 | 15.37 | 41.48 | 83.82 | 106.70 | 6.08 | 21.97 | 70.47 | 105.88 | 127.04 |

| | % Improvement, Aged 1100° C./ | | | | | | |
|---|---|---|---|---|---|---|---|
| | 10 h Air (umol/g) | | | | | | |
| | Temperature ° C. | | | | | | |
| Catalytic | Base | 1.5% Pd/ | | | 0.5% Rh/ | | |
| Washcoat | Metal | Mixed Oxide | | | Mixed Oxide | | |
| Designation | 350 | 200 | 250 | 350 | 200 | 250 | 350 |
| Example 10 | — | — | — | — | — | — | — |
| Example 11 | 382% | −32% | 4% | 6% | 93% | 61% | 17% |
| Example 12 | 279% | −15% | 23% | 9% | −3% | −3% | 8% |

The results in Table 9 and illustrated in FIG. 5 show the OSC of the dried washcoat without addition of PGM (Ex-PGM) post 1100° C./10H Air aging. Example 10 used the mixed oxide of comparative Example 1, which did not contain any of SrO and Fe₂O₃. Example 11 used the mixed oxide of Example 2 (with disclosed mixtures of SrO and Fe₂O₃). Example 12 used the mixed oxide of comparative Example 3, which did not contain any SrO. Example 11 exhibits superior OSC to both Examples 10 and 11 over the tested temperature range (200° C. to 450° C.), demonstrating the presently disclosed compositions unexpectedly improved low temperature OSC.

The results in Table 9 and illustrated in FIG. 6 show the OSC of the dried washcoat with addition of 1.5 wt. % Pd as metal on a mixed oxide basis post 1100° C./10H Air aging. Example 10 used the mixed oxide of comparative Example 1, which did not contain any SrO and Fe₂O₃. Example 11 used the mixed oxide of Example 2 (with disclosed mixtures of SrO and Fe₂O₃). Example 12 used the mixed oxide of comparative Example 3, which did not contain any SrO. FIG. 6 demonstrates 1.5 wt. % Pd has activated the OSC materials versus the non-PGM containing materials as illustrated in FIG. 5.

The results in Table 9 and illustrated in FIG. 7 show the OSC of the dried washcoat with addition of 0.5 wt. % Rh as metal on a mixed oxide basis post 1100° C./10H Air aging. Example 10 used the mixed oxide of comparative Example 1, which did not contain any SrO and Fe₂O₃. Example 11 used the mixed oxide of Example 2 (with disclosed mixtures of SrO and Fe₂O₃). Example 12 used the mixed oxide of comparative Example 3, which did not contain any SrO. Example 11 exhibits superior OSC to both Examples 10 and 11 over the tested temperature range (200° C. to 450° C.), demonstrating the presently disclosed compositions unexpectedly improved low temperature OSC.

As described, the example washcoats of Examples 13-15 were dried/calcined (550° C. for 2 hours) and then the dried slurry powders of these washcoats were aged at 1100° C. for 10 hours in air. After the washcoats of Examples 13-15 were aged/heated at 1100° C./10H Air, OSC measurements were obtained and the % improvements for Examples 14 and 15 in comparison to Example 13 were calculated. This data is summarized in Table 10, and the data was graphed as illustrated in FIG. 8 (0.23 wt. % Rh/MO basis).

TABLE 10
Dried/Calcined Washcoat OSC Data, 0.23% Rh/Mixed Oxide (MO) Basis

| | | 0.23% Rh/MO Basis | | | | | % Improvement, Aged | | |
|---|---|---|---|---|---|---|---|---|---|
| | | Slurry, Aged 1100° C./ | | | | | 1100° C./10h Air (umol/g) | | |
| Catalytic | | 10 h Air (umol/g) | | | | | 0.23 Rh/Mixed Oxide (MO) | | |
| Washcoat | | Temperature ° C. | | | | | Temperature ° C. | | |
| Designation | % Rh/MO | 200 | 250 | 300 | 350 | 450 | 250 | 350 | 450 |
| Example 13 | 0.23% | 0.22 | 6.07 | 29.07 | 67.70 | 110.12 | — | — | — |
| Example 14 | 0.23% | 4.72 | 13.08 | 42.37 | 81.90 | 115.45 | 116% | 21% | 5% |
| Example 15 | 0.23% | 1.37 | 12.5 | 39.65 | 79.64 | 111.49 | 106% | 18% | 1% |

The results in Table 10 and illustrated in FIG. 8 show the OSC of the dried washcoat with addition of 0.23 wt. % Rh as metal on a mixed oxide basis post 1100° C./10H Air aging. Example 13 used the mixed oxide of comparative Example 1, which did not contain any SrO and Fe₂O₃. Example 14 used the mixed oxide of Example 2 (with disclosed mixtures of SrO and Fe₂O₃). Example 15 used the mixed oxide of comparative Example 3, which did not contain any SrO. Example 14 exhibits superior OSC to both Examples 13 and 15 over the tested temperature range (200° C. to 450° C.), demonstrating the presently disclosed compositions unexpectedly improved low temperature OSC. The OSC values were as expected with reduced OSC activation at 0.23 wt % Rh as metal on a mixed oxide basis relative to 0.5 wt. % Rh as metal on a mixed oxide basis.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained.

Notwithstanding that the numerical ranges and parameters setting forth the broad scope of the technology are approximations, the numerical values set forth in the specific examples are reported as precisely as possible. Any numerical value, however, inherently contain certain errors necessarily resulting from the standard deviation found in their respective testing measurements.

It will be clear that the compositions and methods described herein are well adapted to attain the ends and advantages mentioned as well as those inherent therein. Those skilled in the art will recognize that the methods and systems within this specification may be implemented in many manners and as such are not to be limited by the foregoing exemplified embodiments and examples. In this regard, any number of the features of the different embodiments described herein may be combined into one single embodiment and alternate embodiments having fewer than or more than all of the features herein described are possible.

While various embodiments have been described for purposes of this disclosure, various changes and modifications may be made which are well within the scope contemplated by the present disclosure. Numerous other changes may be made which will readily suggest themselves to those skilled in the art and which are encompassed in the spirit of the disclosure.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as disclosed. Thus, it is intended that the present invention include modifications and variations that are within the scope of the appended claims and their equivalents.

What is claimed is:

1. A mixed oxide composition comprising:
a) about 1 to about 45 wt. % cerium on an oxide basis;
b) about 40 to about 98 wt. % zirconium on an oxide basis;
c) about 0.05 wt. % to about 0.50 wt. % iron on an oxide basis;
d) about 0.015 wt. % to about 0.20 wt. % strontium on an oxide basis; and
e) optionally an additional rare earth dopant selected from the group consisting of lanthanum, neodymium, yttrium, praseodymium, samarium, gadolinium, and mixtures thereof, and wherein when present each optional additional rare earth dopant is present in an amount of about 0.5 to about 15 wt. % on an oxide basis.

2. A mixed oxide composition consisting essentially of:
a) about 1 to about 45 wt. % cerium on an oxide basis;
b) about 40 to about 98 wt. % zirconium on oxide basis;
c) about 0.05 wt. % to about 0.50 wt. % iron on an oxide basis;
d) about 0.015 wt. % to about 0.20 wt. % strontium on an oxide basis; and
e) optionally an additional rare earth dopant selected from the group consisting of lanthanum, neodymium, yttrium, praseodymium, samarium, gadolinium, and mixtures thereof, and when present each optional additional rare earth dopant is present in an amount of about 0.5 to about 15 wt. % on an oxide basis.

3. The mixed oxide composition of claim 1, wherein the mixed oxide composition comprises:
a) about 30 to about 45 wt. % cerium on an oxide basis;
b) about 40 to about 65 wt. % zirconium on an oxide basis;
c) about 0.05 wt. % to about 0.50 wt. % iron on an oxide basis;
d) about 0.015 wt. % to about 0.20 wt. % strontium on an oxide basis; and
e) an additional rare earth dopant selected from the group consisting of lanthanum, yttrium, and mixtures thereof present in an amount of about 5 to about 15 wt. % on an oxide basis.

4. The mixed oxide composition of claim 1, wherein the mixed oxide composition exhibits no detectable perovskite or pyrochlore phases as determined by XRD after aging at 1100° C. for 10 hrs in air.

5. The mixed oxide composition of claim 1, wherein the mixed oxide composition exhibits a BET surface area of about 10 m²/g to about 20 m²/g after aging at 1100° C. for 10 hrs in air.

6. The mixed oxide composition of claim 1, wherein the mixed oxide composition has a crystallite size of about 50 nm to about 100 nm after aging at 1100° C. for 10 hrs in air.

7. The mixed oxide composition of any one of claim 1, wherein after aging at 1100° C. for 10 hrs in air, the mixed oxide composition exhibits an Oxygen Storage Capacity (OSC) at about 250° C. to about 600° C. that is about 2 to about 8 times higher than an identical composition not containing a mixture of iron and strontium.

8. The mixed oxide composition of claim 7, wherein the higher Oxygen Storage Capacity (OSC) is at about 250° C. to about 450° C.

9. The mixed oxide composition of claim 1, wherein the mixed oxide composition exhibits an as-prepared BET surface area of about 40 m²/g to about 80 m²/g.

10. The mixed oxide composition of claim 1, wherein the mixed oxide composition exhibits a BET surface area of greater than about 2 m²/g to less than about 10 m²/g after aging at 1150° C. for 6 hrs in air.

11. The mixed oxide composition of claim 10, wherein after aging at 1150° C. for 6 hrs in air, the mixed oxide composition exhibits an Oxygen Storage Capacity (OSC) at about 250° C. to about 600° C. that is about 2 to about 3 times higher than an identical composition not containing a mixture of iron and strontium.

12. The mixed oxide composition of claim 11, wherein the higher Oxygen Storage Capacity (OSC) is at about 250° C. to about 450° C.

13. The mixed oxide composition of claim 10, wherein the mixed oxide composition exhibits a tetragonal phase or cubic phase, with no detectable perovskite or pyrochlore phases as determined by XRD after aging at 1150° C. for 6 hrs in air.

14. The mixed oxide composition of claim 1, wherein H₂TPR (Hydrogen Temperature Programmed Reduction) exhibits a single symmetrical reduction peak after aging at about 1100° C. for 4 hours in air.

15. The mixed oxide composition of claim 1, wherein after aging at 1100° C. for 10 hrs in air, the mixed oxide composition exhibits an Oxygen Storage Capacity (OSC) at about 250° C. to about 600° C. that is about 2 to about 4 times higher than an identical composition not containing a mixture of iron and strontium.

16. The mixed oxide composition of claim 15, wherein the higher Oxygen Storage Capacity (OSC) is at about 250° C. to about 450° C.

17. The mixed oxide composition of claim 1, having a particle size characterized by a D₉₀ of about 6 μm to about 20 μm and a D₁₀ of about 1 μm to about 10 μm.

18. The mixed oxide composition of claim 1, wherein the mixed oxide composition consists essentially of CeO₂, ZrO₂, La₂O₃, Y₂O₃, Fe₂O₃, and SrO.

19. The mixed oxide composition of claim 18, wherein the ratio of Ce/Zr/La/Y/Sr/Fe is approximately 35 wt % to approximately 45 wt % cerium, approximately 45 wt % to approximately 55 wt % zirconium, approximately 3 wt % to approximately 6 wt % lanthanum, approximately 3 wt % to approximately 6 wt % yttrium, approximately 0.03 wt % to approximately 0.2 wt % strontium, and approximately 0.1 wt % to approximately 0.5 wt % iron on an oxide basis.

20. A suspension comprising: (i) a Platinum Group Metal selected from group consisting of platinum, palladium, rhodium, iridium, osmium, ruthenium, and mixtures thereof and (ii) a mixed oxide composition comprising:
a) about 1 to about 45 wt. % cerium on an oxide basis;
b) about 40 to about 98 wt. % zirconium on an oxide basis;
c) about 0.05 wt. % to about 0.50 wt. % iron on an oxide basis;
d) about 0.015 wt. % to about 0.20 wt. % strontium on an oxide basis; and
e) optionally an additional rare earth dopant selected from the group consisting of, lanthanum, neodymium, yttrium, praseodymium, samarium, gadolinium, and mixtures thereof, and when present each optional additional rare earth dopant is present in an amount of about 0.5 to about 15 wt. % on an oxide basis.

21. The suspension of claim 20, wherein the suspension comprises about 55 wt. % to about 65 wt % of the mixed oxide composition.

22. The suspension of claim 20, wherein the Platinum Group Metal is rhodium, and the suspension comprises about 0.2 wt. % to about 0.50 wt. % rhodium as metal on a mixed oxide basis.

23. The suspension of claim 20, wherein the Platinum Group Metal is palladium, and the suspension comprises about 0.5 wt % to about 1.50 wt % palladium as metal on a mixed oxide basis.

24. The suspension of claim 20 further comprising, La₂O₃ doped Al₂O₃, BaSO₄, and pseudoboehmite.

25. The suspension of claim 20, wherein the mixed oxide composition consists essentially of:
a) about 30 to about 45 wt. % cerium on an oxide basis;
b) about 40 to about 65 wt. % zirconium on an oxide basis;
c) about 0.1 wt. % to about 0.50 wt. % iron on an oxide basis;
d) about 0.05 wt. % to about 0.20 wt. % strontium on an oxide basis; and
e) additional rare earth dopant selected from the group consisting of lanthanum, yttrium, and mixtures thereof present in an amount of about 5 to about 15 wt. % on an oxide basis.

26. The composition of claim 20, wherein the mixed oxide composition exhibits no detectable perovskite or pyrochlore phases as determined by XRD after aging at 1100° C. for 10 hrs in air.

27. The suspension of claim 20, further comprising a carboxylic acid.

28. The suspension of claim 20, wherein the suspension has a pH of about 4 to about 6.

29. The suspension of claim 20, wherein when the suspension is dried and calcined, the dried and calcined suspension exhibits an improved Oxygen Storage Capacity (OSC) at about 250° C. to about 600° C. in comparison to a dried and calcined suspension containing a mixed oxide composition with an identical composition but not containing the mixture of iron and strontium.

30. The suspension of claim 29, wherein the dried and calcined suspension contains rhodium as the Platinum Group Metal.
